(19) United States
(12) Patent Application Publication
(10) Pub. No.: US 2026/0135677 A1
(43) Pub. Date: May 14, 2026

(54) RADIO FREQUENCY CHANNEL NUMBERS FOR COMMUNICATING ON-DEMAND SYNCHRONIZATION SIGNAL BLOCKS USING CARRIER AGGREGATION

(71) Applicant: QUALCOMM Incorporated, San Diego, CA (US)

(72) Inventors: Hung Dinh LY, San Diego, CA (US); Jae Ho RYU, San Diego, CA (US)

(21) Appl. No.: 18/941,949

(22) Filed: Nov. 8, 2024

(51) Int. Cl. H04L 5/00

(52) U.S. Cl. CPC H04L 5/0098

(57) ABSTRACT

Various aspects of the present disclosure generally relate to wireless communication. In some aspects, a user equipment (UE) may receive, via a serving cell, at least one of a first frequency channel number for communicating a first type of synchronization reference signal with a secondary serving cell or a second frequency channel number for communicating a second type of synchronization reference signal with the secondary serving cell. The UE may receive one or more synchronization reference signals associated with at least one of the first type of synchronization reference signal or the second type of synchronization reference signal according to at least one of the first frequency channel number or the second frequency channel number. Numerous other aspects are described.

### FIELD OF THE DISCLOSURE

Aspects of the present disclosure generally relate to wireless communication and specifically relate to techniques, apparatuses, and methods associated with radio frequency channel numbers for communicating on-demand synchronization signal blocks using carrier aggregation.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some serving cells may be configured to communicate a type of periodic and/or semi-periodic synchronization signals, such as synchronization signal blocks (SSBs) with a user equipment (UE), sometimes referred to as “always-on” SSBs, to facilitate initial access and synchronization processes. Such semi-periodic SSBs may consume significant power resources when transmitted by a network node associated with the serving cell because the network node may continuously (e.g., semi-continuously) transmit the SSBs at periodic intervals such that synchronization signals may be readily available for UEs to dynamically detect and connect to the serving cell. However, this may prevent the network node from entering a sleep cycle for energy conservation. Further energy may be consumed, in the context of carrier aggregation, when a network node associated with a secondary cell and/or one or more component carriers transmits SSBs at periodic intervals in each available component carrier such that the UE may connect to any of the available component carriers. A secondary serving cell may thus support intermittent or “on-demand” SSBs for connected mode UEs configured for carrier aggregation to improve network energy savings. However, if a serving cell is configured to communicate both always-on SSBs and on-demand SSBs, the UE may blindly monitor and/or track separate frequencies to receive both types of SSBs, which may increase UE complexity and resource consumption and may be incompatible with some wireless communication protocols.

Thus, the indication of frequency channels via which a UE may receive different types of SSBs may support network energy-saving initiatives. For example, a UE that is configured to communicate via carrier aggregation and that is operating in a connected mode (e.g., a radio resource control (RRC) connected mode) may receive, via a serving cell (e.g., a primary serving cell, a secondary serving cell), an indication of a first frequency channel number that corresponds to always-on SSB communication with a secondary serving cell. The first frequency channel number may indicate a radio frequency for communicating always-on SSBs with the secondary serving cell, where the frequency channel number corresponds to a center of a frequency range via which always-on SSBs are communicated by the secondary serving cell. For example, a frequency channel number may indicate a particular resource element (RE) via which an SSB is communicated. Additionally or alternatively, the UE may receive, via the serving cell, an indication of a second frequency channel number that corresponds to on-demand SSB communication with the secondary serving cell. The second frequency channel number may indicate a radio frequency for communicating on-demand SSBs with the secondary serving cell, where the frequency channel number corresponds to a center of a frequency range via which on-demand SSBs are communicated by the secondary serving cell. The UE may receive, from the secondary serving cell, one or more always-on SSBs according to the first frequency channel number and/or may receive one or more on-demand SSBs according to the second frequency channel number. In some aspects, the UE may perform a procedure (e.g., may synchronize communication timing with the secondary serving cell to obtain system information and/or establish a connection) with the secondary serving cell using the one or more always-on SSBs (e.g., received according to the first frequency channel number, received via frequency resources indicated by the first frequency channel number) and/or using the one or more on-demand SSBs (e.g., received according to the second frequency channel number, received via frequency resources indicated by the second frequency channel number).

Some aspects described herein relate to an apparatus for wireless communication at a UE. The apparatus may include one or more memories and one or more processors coupled to the one or more memories. The one or more processors may be configured to receive, via a serving cell, at least one of a first frequency channel number for communicating a first type of synchronization reference signal with a secondary serving cell or a second frequency channel number for communicating a second type of synchronization reference signal with the secondary serving cell. The one or more processors may be configured to receive one or more synchronization reference signals associated with at least one of the first type of synchronization reference signal or the second type of synchronization reference signal according to at least one of the first frequency channel number or the second frequency channel number.

Some aspects described herein relate to an apparatus for wireless communication at a network node. The apparatus may include one or more memories and one or more processors coupled to the one or more memories. The one or more processors may be configured to transmit, to a UE, one or more synchronization reference signals associated with at least one of a first type of synchronization reference signal or a second type of synchronization reference signal according to at least one of a first frequency channel number for communicating the first type of synchronization reference signal or a second frequency channel number for communicating the second type of synchronization reference signal.

Some aspects described herein relate to an apparatus for wireless communication at a network node. The apparatus may include one or more memories and one or more processors coupled to the one or more memories. The one or more processors may be configured to transmit at least one of a first frequency channel number for communication of a first type of synchronization reference signal between a UE and a secondary serving cell or a second frequency channel number for communication of a second type of synchronization reference signal between the UE and the secondary serving cell.

Some aspects described herein relate to a method of wireless communication performed by a UE. The method may include receiving, via a serving cell, at least one of a first frequency channel number for communicating a first type of synchronization reference signal with a secondary serving cell or a second frequency channel number for communicating a second type of synchronization reference signal with the secondary serving cell. The method may include receiving one or more synchronization reference signals associated with at least one of the first type of synchronization reference signal or the second type of synchronization reference signal according to at least one of the first frequency channel number or the second frequency channel number.

Some aspects described herein relate to a method of wireless communication performed by a network node associated with a secondary serving cell. The method may include transmitting, to a UE, one or more synchronization reference signals associated with at least one of a first type of synchronization reference signal or a second type of synchronization reference signal according to at least one of a first frequency channel number for communicating the first type of synchronization reference signal or a second frequency channel number for communicating the second type of synchronization reference signal.

Some aspects described herein relate to a method of wireless communication performed by a network node associated with a serving cell. The method may include transmitting at least one of a first frequency channel number for communication of a first type of synchronization reference signal between a UE and a secondary serving cell or a second frequency channel number for communication of a second type of synchronization reference signal between the UE and the secondary serving cell.

Some aspects described herein relate to a non-transitory computer-readable medium that stores a set of instructions for wireless communication by a UE. The set of instructions, when executed by one or more processors of the UE, may cause the UE to receive, via a serving cell, at least one of a first frequency channel number for communicating a first type of synchronization reference signal with a secondary serving cell or a second frequency channel number for communicating a second type of synchronization reference signal with the secondary serving cell. The set of instructions, when executed by one or more processors of the UE, may cause the UE to receive one or more synchronization reference signals associated with at least one of the first type of synchronization reference signal or the second type of synchronization reference signal according to at least one of the first frequency channel number or the second frequency channel number.

Some aspects described herein relate to a non-transitory computer-readable medium that stores a set of instructions for wireless communication by a network node. The set of instructions, when executed by one or more processors of the network node, may cause the network node to transmit, to a UE, one or more synchronization reference signals associated with at least one of a first type of synchronization reference signal or a second type of synchronization reference signal according to at least one of a first frequency channel number for communicating the first type of synchronization reference signal or a second frequency channel number for communicating the second type of synchronization reference signal.

Some aspects described herein relate to a non-transitory computer-readable medium that stores a set of instructions for wireless communication by a network node. The set of instructions, when executed by one or more processors of the network node, may cause the network node to transmit at least one of a first frequency channel number for communication of a first type of synchronization reference signal between a UE and a secondary serving cell or a second frequency channel number for communication of a second type of synchronization reference signal between the UE and the secondary serving cell.

Some aspects described herein relate to an apparatus for wireless communication. The apparatus may include means for receiving, via a serving cell, at least one of a first frequency channel number for communicating a first type of synchronization reference signal with a secondary serving cell or a second frequency channel number for communicating a second type of synchronization reference signal with the secondary serving cell. The apparatus may include means for receiving one or more synchronization reference signals associated with at least one of the first type of synchronization reference signal or the second type of synchronization reference signal according to at least one of the first frequency channel number or the second frequency channel number.

Some aspects described herein relate to an apparatus for wireless communication. The apparatus may include means for transmitting, to a UE, one or more synchronization reference signals associated with at least one of a first type of synchronization reference signal or a second type of synchronization reference signal according to at least one of a first frequency channel number for communicating the first type of synchronization reference signal or a second frequency channel number for communicating the second type of synchronization reference signal.

Some aspects described herein relate to an apparatus for wireless communication. The apparatus may include means for transmitting at least one of a first frequency channel number for communication of a first type of synchronization reference signal between a UE and a secondary serving cell or a second frequency channel number for communication of a second type of synchronization reference signal between the UE and the secondary serving cell.

Aspects of the present disclosure may generally be implemented by or as a method, apparatus, system, computer program product, non-transitory computer-readable medium, UE, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of physical channels and reference signals in a wireless network, in accordance with the present disclosure.

FIG. 4 is a diagram illustrating examples of carrier aggregation, in accordance with the present disclosure.

FIG. 5A is a diagram illustrating an example of intermittent synchronization signal block (SSB) transmission without periodic SSB transmission by a secondary cell (SCell), in accordance with the present disclosure.

FIG. 5B is a diagram illustrating an example of intermittent SSB transmission with periodic SSB transmission by an SCell, in accordance with the present disclosure.

FIG. 5C is a diagram illustrating an example of intermittent SSB transmission for an activated SCell, in accordance with the present disclosure.

FIG. 6A is a diagram illustrating an example of multi-cell signaling for intermittent SSB transmission, in accordance with the present disclosure.

FIG. 6B is a diagram illustrating an example of multi-cell signaling for intermittent SSB transmission, in accordance with the present disclosure.

FIG. 7 is a diagram of an example associated with radio frequency channel numbers for communicating on-demand SSBs using carrier aggregation, in accordance with the present disclosure.

FIG. 8 is a diagram illustrating an example associated with periodic SSB and intermittent SSB transmission via separate radio frequencies, in accordance with the present disclosure.

FIG. 9 is a diagram illustrating examples associated with spatial domain adaptation for intermittent SSBs, in accordance with the present disclosure.

FIG. 10 is a diagram illustrating an example process performed, for example, at a user equipment (UE) or an apparatus of a UE, in accordance with the present disclosure.

FIG. 11 is a diagram illustrating an example process performed, for example, at a network node or an apparatus of a network node, in accordance with the present disclosure.

FIG. 12 is a diagram illustrating an example process performed, for example, at a network node or an apparatus of a network node, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Certain network components transmit synchronization signal and/or physical broadcast channel (PBCH) blocks (SSBs), which help facilitate the initial access and synchronization processes for a user equipment (UE). SSBs may generally include two components: the primary synchronization signal (PSS) and the secondary synchronization signal (SSS). SSBs provide for time-domain synchronization, frequency-domain synchronization, cell search and identification, system information acquisition, and network access.

SSBs may be communicated via two different modalities. For example, some serving cells may be configured to communicate a type of periodic and/or semi-periodic SSB to a UE, sometimes referred to as always-on SSBs, to facilitate initial access and synchronization processes. Such periodic and/or semi-periodic SSBs may consume significant power resources when transmitted by a network node associated with the serving cell because the network node may continuously (e.g., continuously, semi-continuously, regularly) transmit the SSBs at periodic intervals such that synchronization signals may be readily available for UEs to dynamically detect and connect to the serving cell. Some serving cells may be configured to communicate intermittent bursts of periodic SSBs, sometimes referred to as on-demand SSBs, to facilitate initial access and synchronization processes with a secondary cell for carrier aggregation.

One type of SSB is a cell-defining SSB (CD-SSB). The CD-SSB includes the PSS, SSS, and cell identification information, which may include a cell identifier, frame timing, and system information. The cell identification information helps the UE distinguish between different cells in the network and establish a connection with the appropriate cell. When an SSB is not associated with a remaining minimum system information (RMSI) (e.g., system information block (SIB) 1 (SIB1)), the SSB is referred to as a non-cell-defining SSB (NCD-SSB), which can be used to perform radio link monitoring (RLM), bidirectional forwarding detection (BFD), and radio resource management (RRM) measurements and measurements for resource allocation (RA) resource selection inside the active downlink bandwidth part (BWP) when the active BWP does not contain the CD-SSB. A UE may be configured with multiple SSBs provided that each BWP is configured with at most one SSB (e.g., CD-SSB or NCD-SSB). The NCD-SSB includes the PSS and SSS but omits the cell identification information. NCD-SSBs may help with redundancy, improve signal coverage, or assist in network load balancing. Both periodic SSBs and intermittent SSBs may include NCD-SSBs and/or CD-SSBs, and a network node may be configured to communicate various combinations of SSBs.

Some serving cells may be configured to communicate periodic and/or semi-periodic SSB to a UE, such as always-on SSBs, to facilitate initial access and synchronization processes. Such semi-periodic SSBs may consume significant power resources when transmitted by a network node associated with the serving cell because the network node may continuously transmit the SSBs at periodic intervals so that synchronization signals may be readily available for UEs to dynamically detect and connect to the serving cell. Further energy may be consumed, in the context of carrier aggregation, when a network node associated with a secondary cell and/or one or more component carriers transmits SSBs at periodic intervals in each available component carrier such that the UE may connect to any of the available component carriers. A secondary serving cell may thus support intermittent or on-demand SSBs for connected mode UEs configured for carrier aggregation to improve network energy savings. However, if a serving cell is configured to communicate both always-on SSBs and on-demand SSBs, the UE may blindly monitor and/or track separate frequencies to receive both types of SSBs, which may increase UE complexity and resource consumption and may be incompatible with some wireless communication protocols.

Various aspects generally relate to the indication of frequency channels via which a UE may receive different types of SSBs that may support network energy-saving initiatives. For example, a UE that is configured to communicate via carrier aggregation and that is operating in a connected mode (e.g., a radio resource control (RRC) connected mode) may receive, via a serving cell (e.g., a primary serving cell, a secondary serving cell), an indication of a first frequency channel number that corresponds to always-on SSB communication with a secondary serving cell. The first frequency channel number may indicate a radio frequency for communicating always-on SSBs with the secondary serving cell, where the frequency channel number corresponds to a center of a frequency range via which always-on SSBs are communicated by the secondary serving cell. For example, a frequency channel number may indicate a particular resource element (RE) via which an SSB is communicated. Additionally or alternatively, the UE may receive, via the serving cell, an indication of a second frequency channel number that corresponds to on-demand SSB communication with the secondary serving cell. The second frequency channel number may indicate a radio frequency for communicating on-demand SSBs with the secondary serving cell, where the frequency channel number corresponds to a center of a frequency range via which on-demand SSBs are communicated by the secondary serving cell. The UE may receive, from the secondary serving cell, one or more always-on SSBs according to the first frequency channel number and/or may receive one or more on-demand SSBs according to the second frequency channel number. In some aspects, the UE may perform a procedure (e.g., such as an initial access procedure with a network node, and/or the UE may synchronize communication timing with the secondary serving cell to obtain system information and/or establish a connection) with the secondary serving cell using the one or more always-on SSBs (e.g., received according to the first frequency channel number, received via frequency resources indicated by the first frequency channel number) and/or using the one or more on-demand SSBs (e.g., received according to the second frequency channel number, received via frequency resources indicated by the second frequency channel number).

In a first example, a secondary serving cell may be configured to communicate periodic CD-SSBs and/or intermittent NCD-SSBs. In such aspects, a network node associated with a secondary cell may transmit each type of SSB via a separate frequency. For example, the network node may transmit periodic SSBs via a synchronization raster frequency(ies) (e.g., absoluteFrequencySSB) indicated to a UE by a downlink configuration message (e.g., DownlinkConfigCommon) and may transmit intermittent SSBs via a frequency that is not indicated by the downlink configuration message (e.g., is different from the synchronization raster frequency(ies) sync raster (e.g., in frequency(ies) indicated by a new RRC parameter). In such examples, the secondary serving cell may not support initial cell selection but may support cell reselection based on the periodic SSBs. However, if both the periodic SSBs and the intermittent SSBs are configured for a particular procedure (e.g., layer 1 (L1)/layer 3 (L3) measurement, radio link management or beam management), the UE may track the SSB in two separate frequencies, which may prompt the UE to perform additional radio frequency retuning and/or may contradict some existing communication protocols in which the SSBs configured for a particular procedure or defined as occurring via the same frequency. In the context of carrier aggregation, if a UE were to track the SSBs in two separate frequencies for each secondary cell, UE complexity may increase because multiple secondary cells may communicate a combination of periodic CD-SSBs and/or intermittent NCD-SSBs.

In a second example, a secondary serving cell may be configured to communicate periodic NCD-SSBs and/or intermittent NCD-SSBs. The secondary serving cell may communicate both periodic SSBs and intermittent SSBs via a same frequency, which may avoid the complexity discussed for the combination of periodic CD-SSBs and intermittent NCD-SSBs communicated via different frequencies. In such examples, the secondary serving cell may transmit a synchronization raster frequency(ies) (e.g., absoluteFrequencySSB) to a UE by a downlink configuration message (e.g., DownlinkConfigCommon) that may be used for both periodic SSBs and intermittent SSBs (e.g., no additional RRC parameter is used to indicate absolute frequency (e.g., in terms of absolute radio frequency channel number (ARFCN)) for intermittent SSB communication). In such examples, periodic SSBs and intermittent SSBs may or may not overlap in the time domain. In the example where periodic SSBs and intermittent SSBs do not overlap in the time domain, in some aspects, periodic SSBs and intermittent SSBs may be communicated according to a time offset. In the example where periodic SSBs and intermittent SSBs overlap in the time domain, in some aspects, periodic SSBs and intermittent SSBs may fully overlap during a time resource (e.g., colliding occasion) (e.g., partial collision of periodic SSBs and intermittent SSBs may be prohibited). In such aspects, a configuration for periodic SSBs (e.g., frequency, ssb-PositionsInBurst, ss-PBCH-BlockPower) may be the same as a configuration for intermittent SSBs. In some aspects, if periodic SSBs and intermittent SSBs are transmitted via different radio frequencies, the UE may track the SSBs in two separate frequencies for each secondary cell, and UE complexity may increase because multiple secondary cells may communicate a combination of periodic NCD-SSBs and/or intermittent NCD-SSBs.

Particular aspects of the subject matter described in this disclosure can be implemented to realize one or more of the following potential advantages. In some examples, the described techniques can be used to increase network energy efficiency by implementing intermittent SSB transmission in scenarios where periodic SSB transmission alone may cause increased complexity and resource consumption by a UE and/or a network node. For example, by communicating, via a serving cell, at least one of the first frequency channel number and/or the second frequency channel number, the UE may sense SSBs efficiently and according to the indicated frequency channel numbers. Additionally, the UE may extrapolate and/or assume other parameters without additional signaling based on whether the frequency channel numbers are the same and/or different. By communicating the one or more synchronization reference signals associated with the first type of synchronization reference signal and/or the second type of synchronization reference signal, the UE may select a most suitable and/or convenient type of synchronization reference signal for measurement and/or synchronization as part of an SCell activation procedure, which increases flexibility at the UE. Additionally, by implementing the second type of synchronization reference signal, a network node supporting the SCell may conserve energy by refraining from transmitting and/or reducing a quantity of transmission occasions (e.g., increasing a periodicity) of the first type of synchronization reference signal. By the second frequency channel number being the same as the first frequency channel number, the UE may reduce complexity and avoid monitoring and/or measuring multiple frequency bands for different types of SSBs. By the second frequency channel number being different from the first frequency channel number, the UE may increase flexibility by selecting which type of SSB to use for SCell synchronization.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

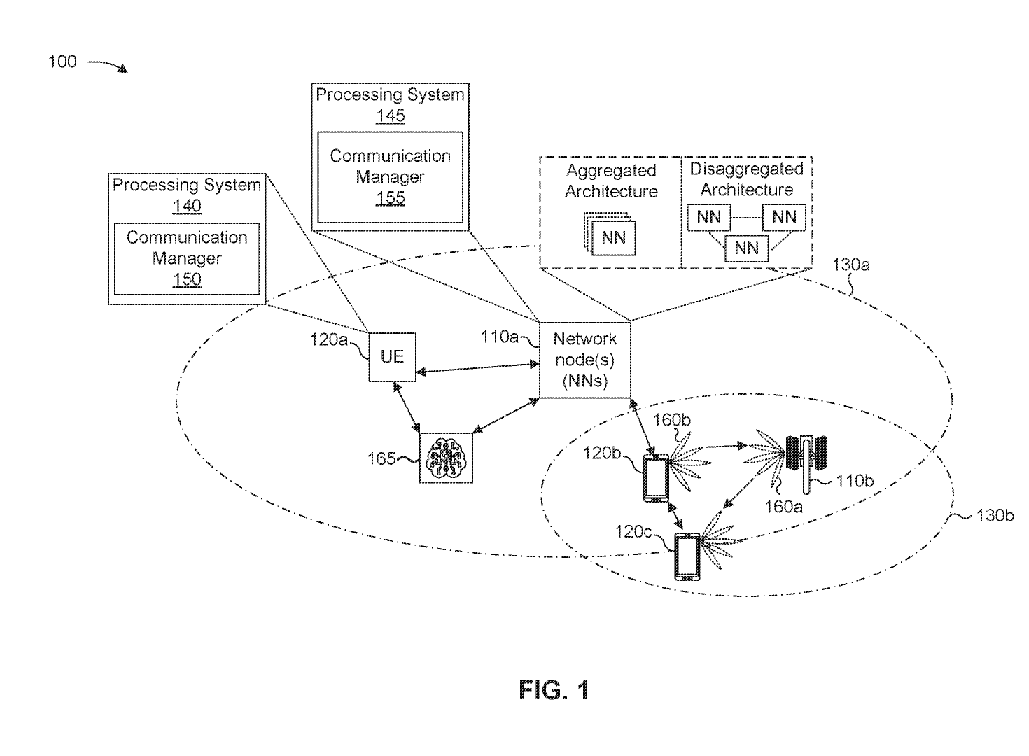

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

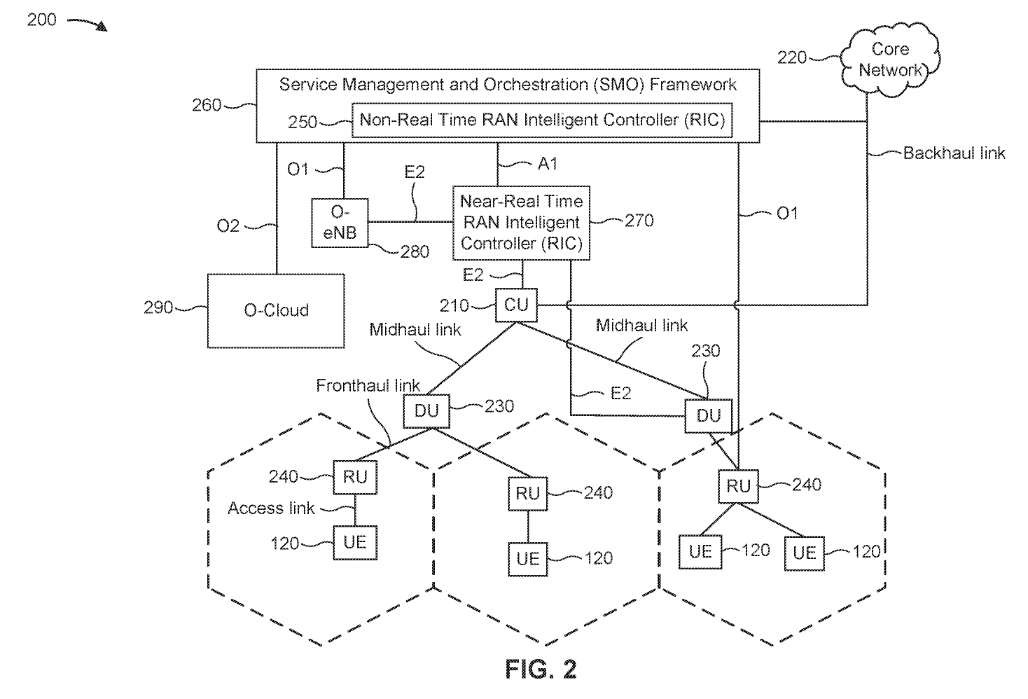

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a PSS, an SSS, an SS block (SSB) (for example, that includes a PSS, an SSS, and a PBCH), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify resource blocks in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

As indicated above, a BWP may be configured as a subset or a part of a total or full component carrier bandwidth and generally forms or encompasses a set of contiguous resource blocks within the full component carrier bandwidth. In other words, within the carrier bandwidth, a BWP starts at a specifically configured resource block and may span a specific set of consecutive resource blocks. Each BWP may be associated with its own numerology (indicating a sub-carrier spacing (SCS) and cyclic prefix (CP)). A UE 120 may be configured with up to four downlink BWPs and up to four uplink BWPs for each serving cell. To reduce UE power consumption, only one BWP in the downlink and one BWP in the uplink are generally active at a given time on an active serving cell under typical operation. The active BWP defines the operating bandwidth of the UE 120 within the operating bandwidth of the serving cell while all other BWPs with which the UE 120 is configured are deactivated. On deactivated BWPs, the UE 120 does not transmit or receive any communications.

Network energy saving (NES) and/or network energy efficiency measures are expected to have increased importance in wireless network operations for various reasons, such as climate change mitigation, environmental sustainability, and/or network cost reduction, among other examples. For example, although NR generally offers a significant energy efficiency improvement per gigabyte over previous generations (for example, LTE), new NR use cases and/or the adoption of millimeter wave frequencies may require more network sites, more network antennas, larger bandwidths, and/or more frequency bands, among other examples which may lead to more efficient wireless networks that nonetheless have higher energy requirements and/or cause more emissions than previous wireless network generations. Furthermore, energy accounts for a significant proportion of the cost to operate a wireless network. For example, according to some estimates, energy costs are about one-fourth the total cost to operate a wireless network, and over 90% of network operating costs are spent on energy (for example, fuel and electricity). The largest proportion of energy consumption and/or energy costs are associated with a radio access network (RAN), which accounts for about half of the energy consumption in a wireless network, with data centers and fiber transport accounting for smaller shares. Accordingly, measures to increase network energy savings and/or improve network energy efficiency are factors that may drive adoption and/or expansion of wireless networks.

In some examples, a UE 120 or network node 110 may implement power saving features (also referred to as energy saving features). Power saving features may include, for example, relaxed radio resource monitoring (such as relaxed reference signal monitoring for devices operating in low mobility or in good radio conditions), discontinuous reception (DRX) operation, reduced PDCCH monitoring during DRX active times, on-demand system information transmission, on-demand SSB transmission, antenna port adaptation, advanced channel state information (CSI) reporting, and/or power-efficient paging reception.

In some examples, a UE 120 may operate in association with a DRX configuration (for example, indicated to the UE 120 by a network node 110). DRX operation may enable the UE 120 to enter a sleep mode or state at various times while in the coverage area of a network node 110 to reduce power consumption for conserving battery resources, among other examples. The DRX configuration generally configures the UE 120 to operate in association with a DRX cycle. The UE 120 may repeat DRX cycles with a configured periodicity according to the DRX configuration. A DRX cycle may include a DRX on duration during which the UE 120 is in an awake mode or in an active state. A DRX cycle may also include one or more durations during which the UE 120 may operate in an inactive state. The one or more durations in which the UE 120 may operate in an inactive state may be opportunities for the UE 120 to enter a DRX sleep mode in which the UE 120 may refrain from monitoring for communications from a network node 110. Additionally or alternatively, the UE 120 may deactivate one or more antennas, RF chains, and/or other hardware components or devices while operating in the DRX sleep mode.

The time during which the UE 120 is configured to be in an active state during a DRX on duration may be referred to as an active time, and the time during which the UE 120 is configured to be in an inactive state, such as during a DRX sleep duration, may be referred to as an inactive time. During a DRX on duration, the UE 120 may monitor for downlink communications from one or more network nodes 110. If the UE 120 does not detect and/or does not successfully decode any downlink communications during the DRX on duration, the UE 120 may enter a DRX sleep mode for the inactive time duration at the end of the DRX on duration. If the UE 120 detects and/or successfully decodes a downlink communication during the DRX on duration, the UE 120 may remain in the active state for the duration of a DRX inactivity timer (which may extend the active time). The UE 120 may start the DRX inactivity timer at a time at which the downlink communication is received. The UE 120 may remain in the active state until the DRX inactivity timer expires, at which time the UE 120 may transition to the sleep mode for an inactive time duration. Additionally or alternatively, the UE 120 may use a DRX cycle referred to as an extended DRX (eDRX) cycle, such as for use cases that are tolerant to latency. An eDRX cycle may include a relatively longer inactive time relative to a baseline DRX cycle (for example, an eDRX cycle may have a lower ratio of active time to inactive time).

In some aspects, the UE 120 may include a communication manager 150. As described in more detail elsewhere herein, the communication manager 150 may receive, via a serving cell, at least one of a first frequency channel number for communicating a first type of synchronization reference signal with a secondary serving cell or a second frequency channel number for communicating a second type of synchronization reference signal with the secondary serving cell; and receive one or more synchronization reference signals associated with at least one of the first type of synchronization reference signal or the second type of synchronization reference signal according to at least one of the first frequency channel number or the second frequency channel number. Additionally, or alternatively, the communication manager 150 may perform one or more other operations described herein.

In some aspects, the network node 110 may include a communication manager 155. As described in more detail elsewhere herein, the communication manager 155 may transmit, to a UE, one or more synchronization reference signals associated with at least one of a first type of synchronization reference signal or a second type of synchronization reference signal according to at least one of a first frequency channel number for communicating the first type of synchronization reference signal or a second frequency channel number for communicating the second type of synchronization reference signal. Additionally, or alternatively, the communication manager 155 may perform one or more other operations described herein.

As described in more detail elsewhere herein, the communication manager 155 may transmit at least one of a first frequency channel number for communication of a first type of synchronization reference signal between a UE and a secondary serving cell or a second frequency channel number for communication of a second type of synchronization reference signal between the UE and the secondary serving cell. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

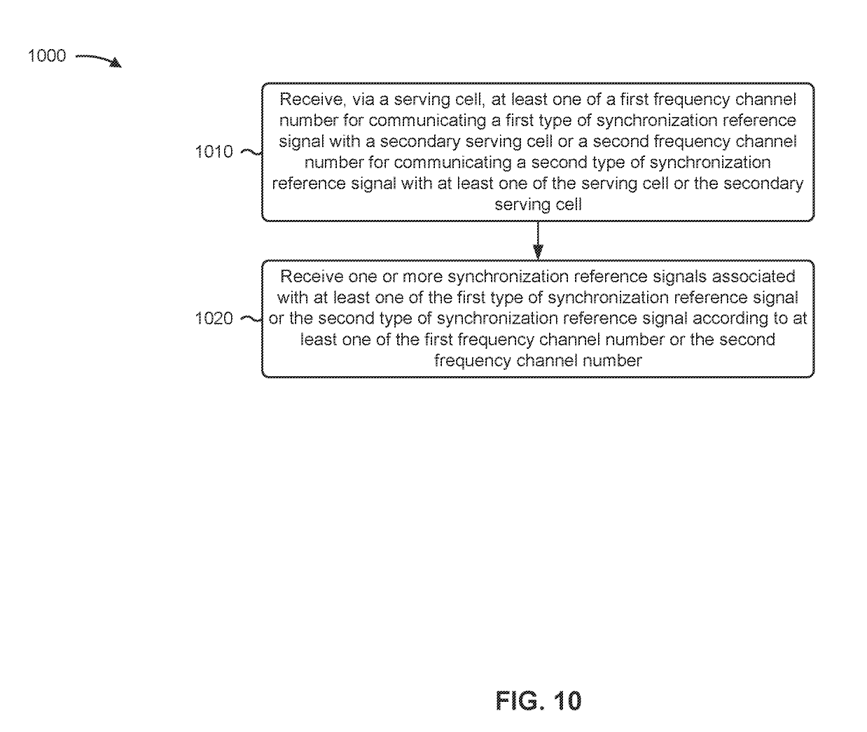

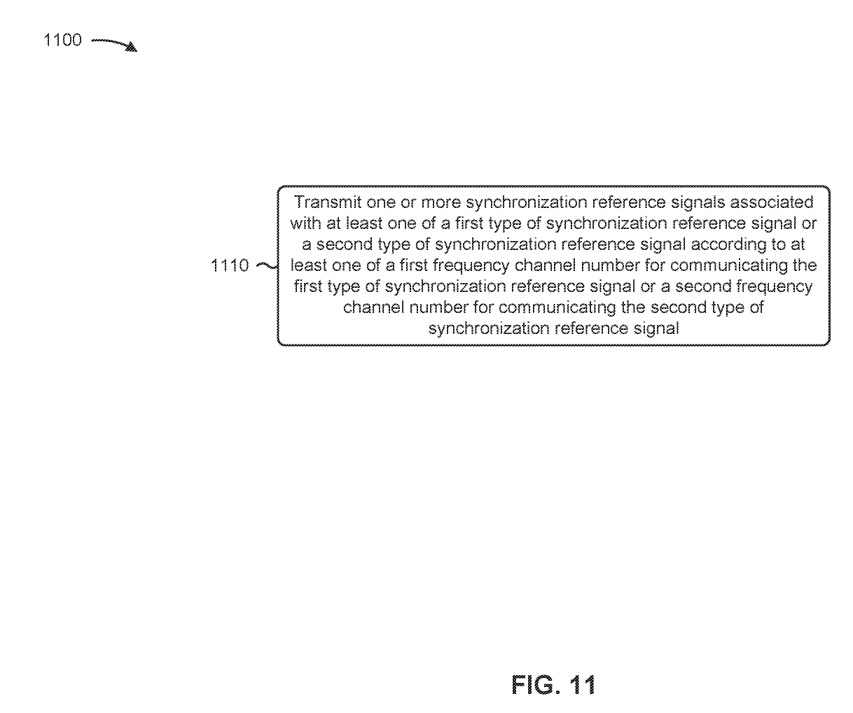

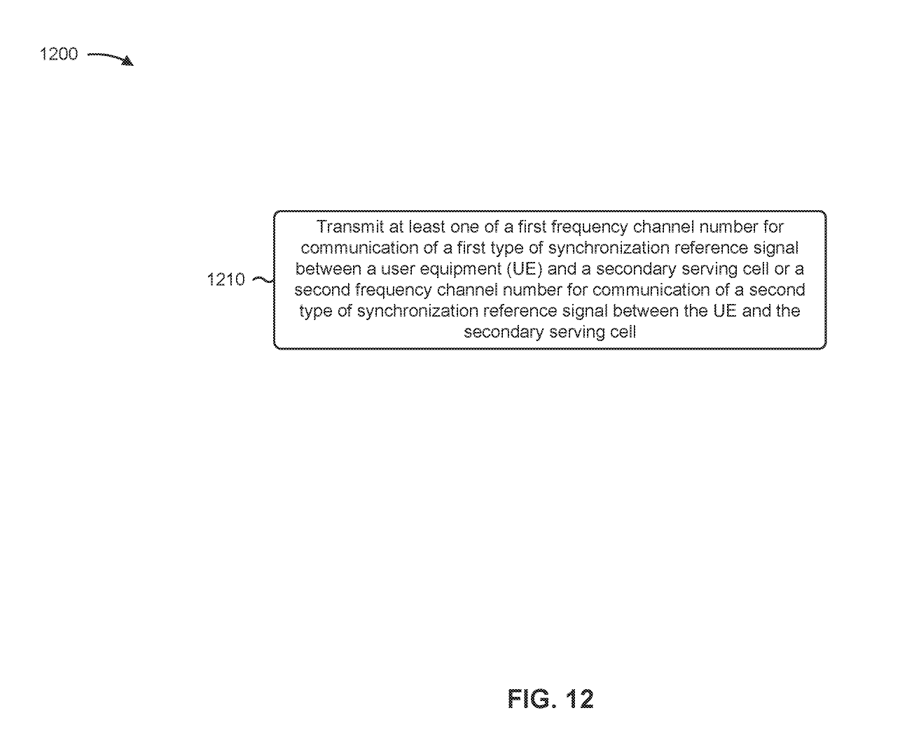

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with radio frequency channel numbers identification for communicating on-demand SSBs using carrier aggregation, as described in more detail elsewhere herein. For example, the processing system 145 of the network node 110, the processing system 140 of the UE 120, the CU 210, the DU 230, or the RU 240 may perform or direct operations of, for example, process 1000 of FIG. 10, process 1100 of FIG. 11, process 1200 of FIG. 12, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1000 of FIG. 10, process 1100 of FIG. 11, process 1200 of FIG. 12, or other processes as described herein. In some examples, executing instructions may include running the instructions, converting the instructions, compiling the instructions, and/or interpreting the instructions, among other examples.

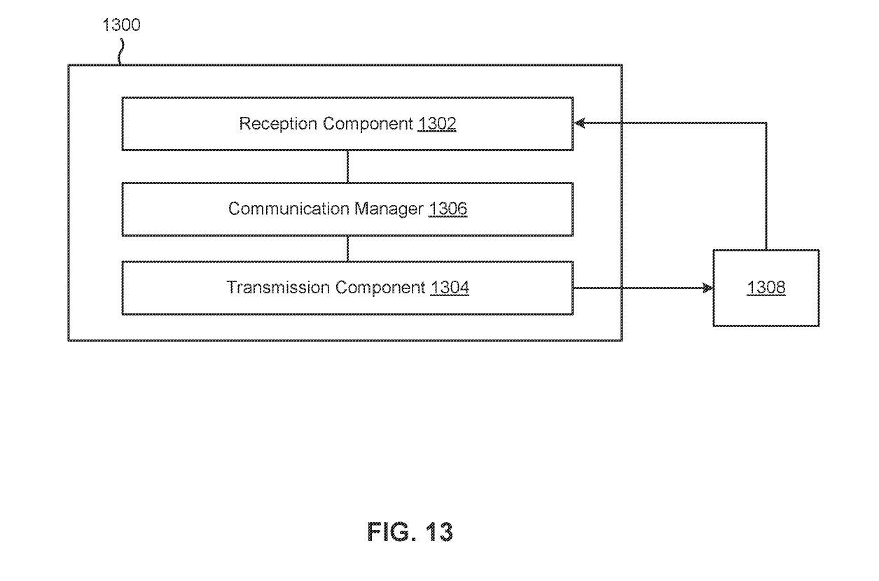

In some aspects, the UE 120 includes means for receiving, via a serving cell, at least one of a first frequency channel number for communicating a first type of synchronization reference signal with a secondary serving cell or a second frequency channel number for communicating a second type of synchronization reference signal with the secondary serving cell; and/or means for receiving one or more synchronization reference signals associated with at least one of the first type of synchronization reference signal or the second type of synchronization reference signal according to at least one of the first frequency channel number or the second frequency channel number. The means for the UE 120 to perform operations described herein may include, for example, one or more of communication manager 150, processing system 140, a radio, one or more RF chains, one or more transceivers, one or more antennas, one or more modems, a reception component (for example, reception component 1302 depicted and described in connection with FIG. 13), and/or a transmission component (for example, transmission component 1304 depicted and described in connection with FIG. 13), among other examples.

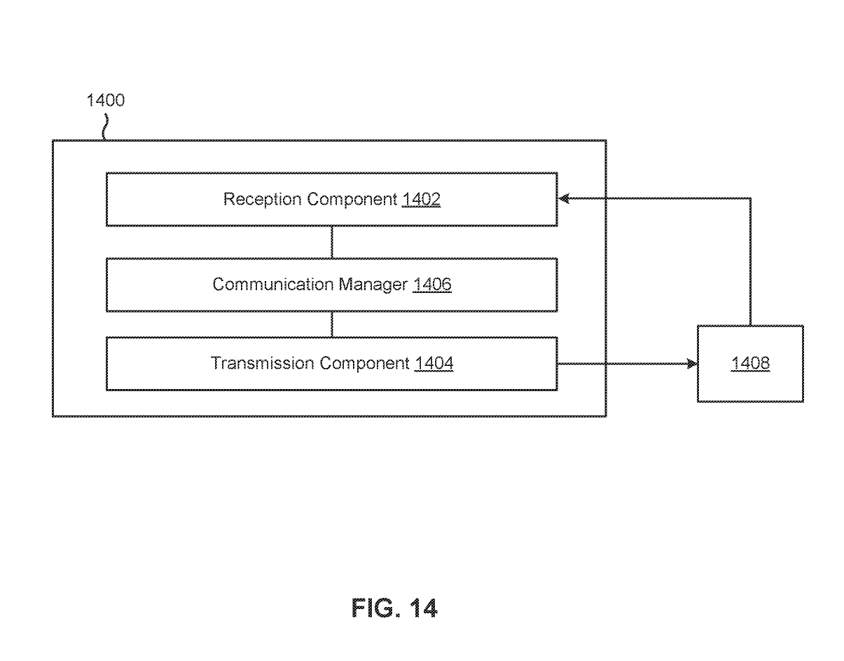

In some aspects, the network node 110 includes means for transmitting, to a UE, one or more synchronization reference signals associated with at least one of a first type of synchronization reference signal or a second type of synchronization reference signal according to at least one of a first frequency channel number for communicating the first type of synchronization reference signal or a second frequency channel number for communicating the second type of synchronization reference signal. The means for the network node 110 to perform operations described herein may include, for example, one or more of communication manager 155, processing system 145, a radio, one or more RF chains, one or more transceivers, one or more antennas, one or more modems, a reception component (for example, reception component 1402 depicted and described in connection with FIG. 14), and/or a transmission component (for example, transmission component 1404 depicted and described in connection with FIG. 14), among other examples.

In some aspects, the network node 110 includes means for transmitting at least one of a first frequency channel number for communication of a first type of synchronization reference signal between a UE and a secondary serving cell or a second frequency channel number for communication of a second type of synchronization reference signal between the UE and the secondary serving cell. The means for the network node 110 to perform operations described herein may include, for example, one or more of communication manager 155, processing system 145, a radio, one or more RF chains, one or more transceivers, one or more antennas, one or more modems, a reception component (for example, reception component 1402 depicted and described in connection with FIG. 1), and/or a transmission component (for example, transmission component 1404 depicted and described in connection with FIG. 14), among other examples.

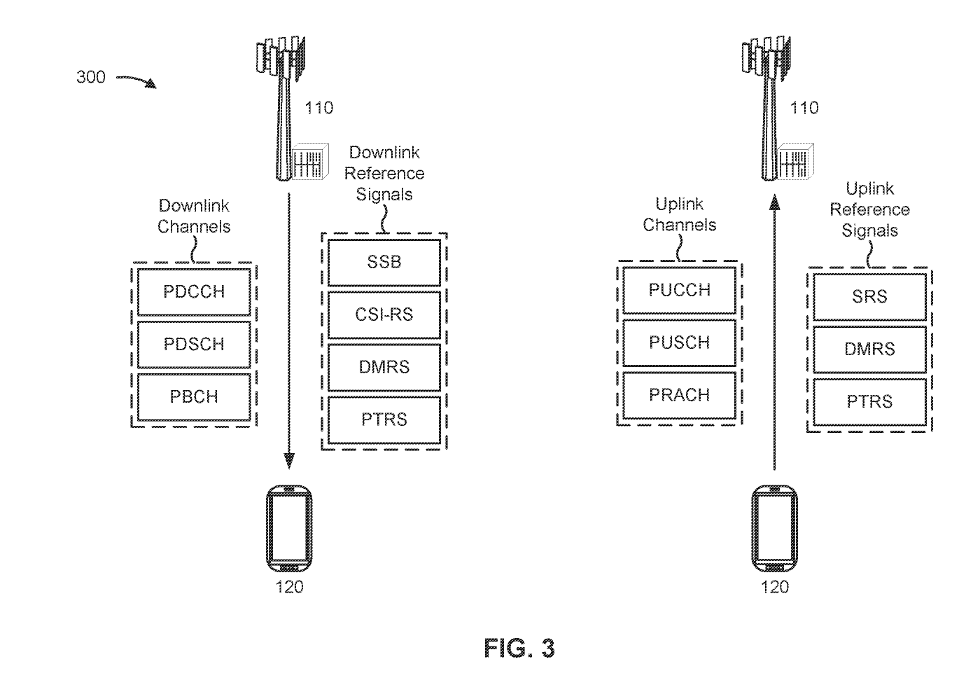

FIG. 3 is a diagram illustrating an example 300 of physical channels and reference signals in a wireless network, in accordance with the present disclosure. As shown in FIG. 3, downlink channels and downlink reference signals may carry information from a network node 110 to a UE 120, and uplink channels and uplink reference signals may carry information from a UE 120 to a network node 110.

As shown, a downlink channel may include a physical downlink control channel (PDCCH) that carries downlink control information (DCI), a physical downlink shared channel (PDSCH) that carries downlink data, or a PBCH that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include an SSB, a channel state information (CSI) reference signal (CSI-RS), a demodulation reference signal (DMRS), a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a PSS, an SSS, a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The network node 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

One type of SSB is a CD-SSB. The CD-SSB may include the PSS, SSS, and cell identification information, which may include a cell identifier, frame timing, and system information. The cell identification information helps the UE to distinguish between different cells in the network and establish a connection with the appropriate cell. When an SSB is not associated with an RMSI (e.g., SIB1), the SSB is referred to as an NCD-SSB, which can be used to perform RLM, BFD, and RRM measurements and measurements for resource allocation (RA) resource selection inside the active downlink BWP when the active BWP does not contain the CD-SSB. A UE may be configured with multiple SSBs provided that each BWP is configured with at most one SSB (e.g., CD-SSB or NCD-SSB). The NCD-SSB may include the PSS and SSS but omit the cell identification information. NCD-SSBs may help with redundancy, improving signal coverage, or assisting in network load balancing. Both periodic SSBs and intermittent SSBs may include NCD-SSBs and/or CD-SSBs, and a network node may be configured to communicate various combinations of SSBs.

SSBs may be communicated via two different modalities. For example, some serving cells may be configured to communicate a type of periodic and/or semi-periodic SSB to a UE, sometimes referred to as always-on SSBs, to facilitate initial access and synchronization processes. Such periodic and/or semi-periodic SSBs may consume significant power resources when transmitted by a network node associated with the serving cell, because the network node may continuously (e.g., continuously, semi-continuously, regularly) transmit the SSBs at periodic intervals such that synchronization signals may be readily available for UEs to dynamically detect and connect to the serving cell. Some serving cells may be configured to communicate intermittent bursts of periodic SSBs, sometimes referred to as on-demand SSBs, to facilitate initial access and synchronization processes with a secondary cell for carrier aggregation.

As indicated above, FIG. 3 is provided as an example. Other examples may differ from what is described with regard to FIG. 3.

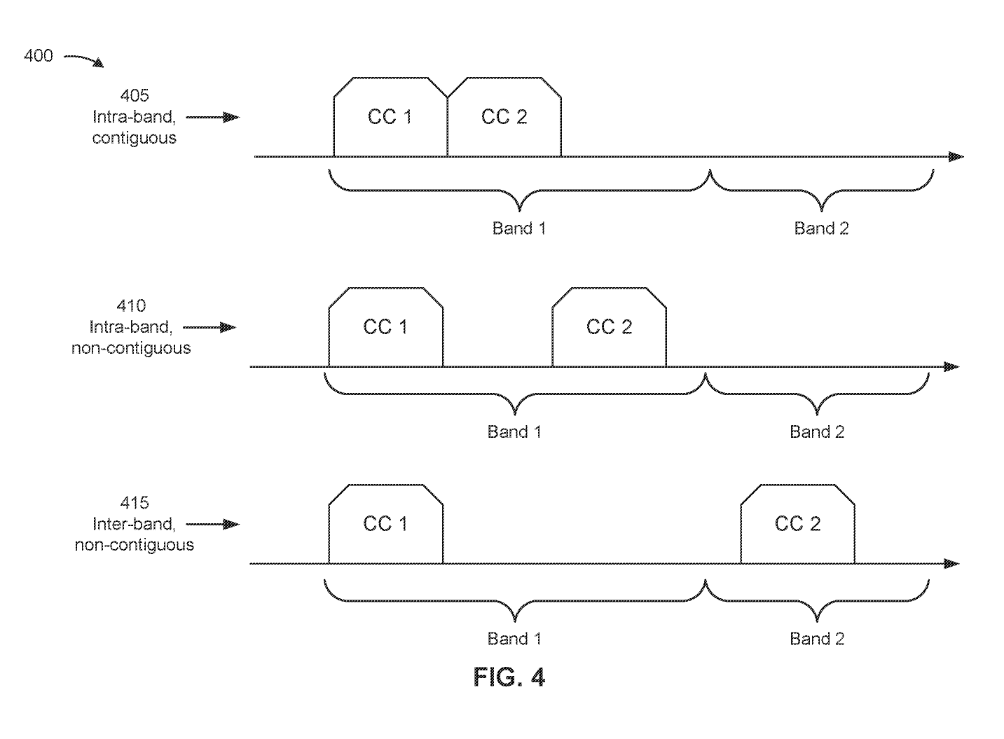

FIG. 4 is a diagram illustrating examples 400 of carrier aggregation, in accordance with the present disclosure.

Carrier aggregation is a technology that enables two or more component carriers (CCs, sometimes referred to as carriers) to be combined (e.g., into a single channel) for a single UE 120 to enhance data capacity. As shown, carriers can be combined in the same or different frequency bands. Additionally, or alternatively, contiguous or non-contiguous carriers can be combined. A network node 110 may configure carrier aggregation for a UE 120, such as in an RRC message, downlink control information (DCI), and/or another signaling message.

As shown by reference number 405, in some aspects, carrier aggregation may be configured in an intra-band contiguous mode where the aggregated carriers are contiguous to one another and are in the same band. As shown by reference number 410, in some aspects, carrier aggregation may be configured in an intra-band non-contiguous mode where the aggregated carriers are non-contiguous to one another and are in the same band. As shown by reference number 415, in some aspects, carrier aggregation may be configured in an inter-band non-contiguous mode where the aggregated carriers are non-contiguous to one another and are in different bands.

In carrier aggregation, a UE 120 may be configured with a primary carrier or primary cell (PCell) and one or more secondary carriers or secondary cells (SCells). In some aspects, the primary carrier may carry control information (e.g., downlink control information and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

An SCell may be configured to communicate periodic CD-SSBs and/or intermittent NCD-SSBs. In such aspects, a network node associated with the SCell may transmit each type of SSB via a separate frequency. The SCell may not support initial cell selection but may support cell reselection based on the periodic SSBs. However, if both the periodic SSBs and the intermittent SSBs are configured for a particular procedure (e.g., L1/L3 measurement, radio link management or beam management), the UE may track the SSBs in two or more separate frequencies, which may prompt the UE to perform additional radio frequency retuning and/or may contradict some existing communication protocols in which the SSBs configured for a particular procedure are defined as occurring via the same frequency. In the context of carrier aggregation, if a UE were to track the SSBs in two separate frequencies for each SCell, UE complexity may increase because multiple SCells may communicate a combination of periodic CD-SSBs and/or intermittent NCD-SSBs.

An SCell may, additionally or alternatively, be configured to communicate periodic NCD-SSBs and/or intermittent NCD-SSBs. The SCell may communicate both periodic SSBs and intermittent SSBs via a same frequency, which may avoid the complexity discussed for the combination of periodic CD-SSBs and intermittent NCD-SSBs communicated via different frequencies. In some aspects, if periodic SSBs and intermittent SSBs are transmitted via different radio frequencies, the UE may track the SSB in two separate frequencies for each SCell, and UE complexity may increase because multiple SCells may communicate a combination of periodic NCD-SSBs and/or intermittent NCD-SSBs.

As indicated above, FIG. 4 is provided as an example. Other examples may differ from what is described with regard to FIG. 4.

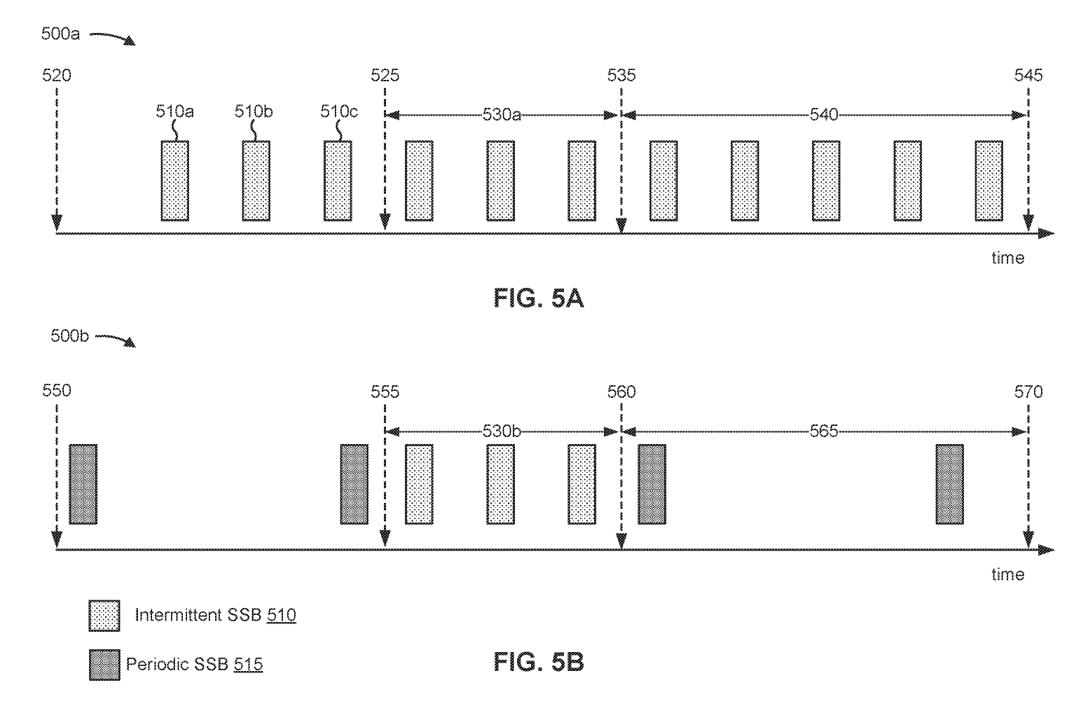

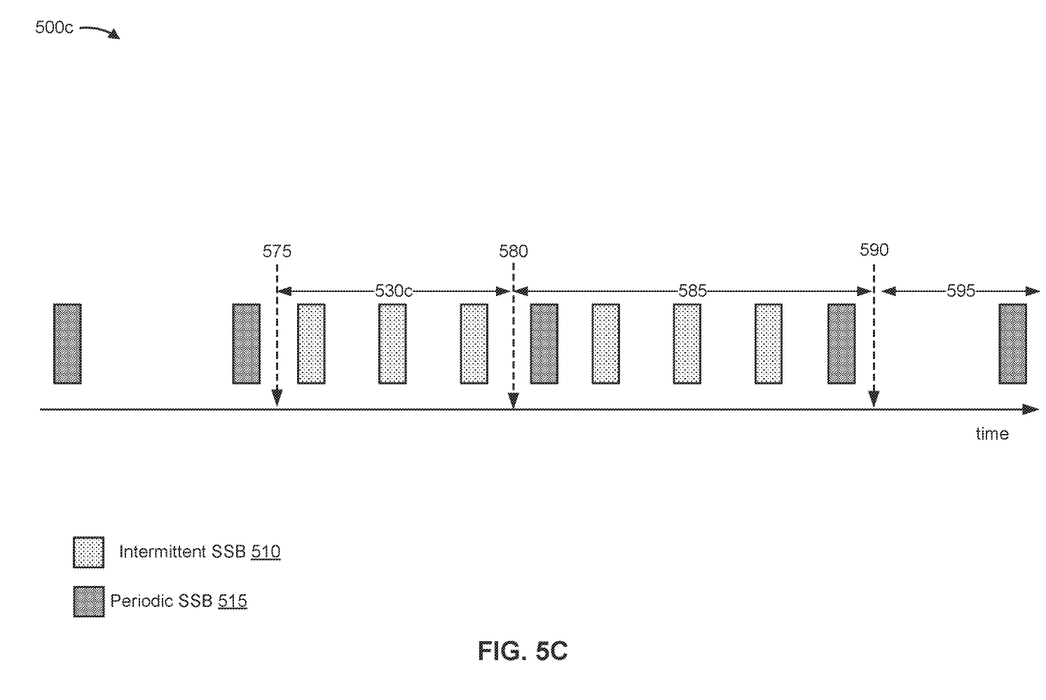

FIG. 5A is a diagram illustrating an example 500a of intermittent SSB transmission without periodic SSB transmission by an SCell, in accordance with the present disclosure. The example 500a illustrates a scenario in which an SCell is configured for intermittent SSB transmission and is not configured and/or does not support periodic SSB transmission. The example 500a includes a set of intermittent SSBs 510 transmitted via an SCell associated with a UE (e.g., UE 120 described in connection with FIG. 1). As shown by reference number 520, the SCell may be configured. For example, the UE may detect the SCell, perform one or more actions to prepare for activation of and/or to access the SCell, and/or be configured to activate the SCell for carrier aggregation. The UE may perform synchronization with the SCell, and/or may perform one or more measurements (e.g., layer 1 measurement and/or layer 2 measurement) using the intermittent SSB 510a, the intermittent SSB 510b, and the intermittent SSB 510c. As shown by reference number 525, the UE may receive an SCell activation command. For example, the UE may receive an RRC message and/or a MAC-CE including the SCell activation command. Transition period 530a may be a transition period during which the UE and/or the SCell perform one or more procedures in association with the activation of the SCell. As shown by reference number 535, the SCell activation may be complete. The time period 540 may be an activated period during which the UE and the SCell perform one or more communications. As shown by reference number 545, the UE may receive an SCell deactivation command. For example, the UE may receive a MAC-CE including the SCell deactivation command.

FIG. 5B is a diagram illustrating an example 500b of intermittent SSB transmission with periodic SSB transmission by an SCell, in accordance with the present disclosure. The example 500b illustrates a scenario in which an SCell is configured for intermittent SSB transmission and periodic SSB transmission. The example 500b includes a set of intermittent SSBs 510 transmitted via an SCell associated with a UE (e.g., UE 120 described in connection with FIG. 1) and a set of periodic SSBs 515 transmitted via the SCell associated with the UE. As shown by reference number 550, the SCell may be configured. For example, the UE may detect the SCell, perform one or more actions to prepare for activation of the SCell, and/or be configured to activate the SCell for carrier aggregation. As shown by reference number 555, the UE may receive an SCell activation command. For example, the UE may receive an RRC message and/or a MAC-CE including the SCell activation command. Transition period 530b may be a transition period during which the UE and/or the SCell perform one or more procedures in association with the activation of the SCell. As shown by reference number 560, the SCell activation may be complete. In some examples, the SCell activation may terminate the communication of intermittent SSBs 510. The time period 565 may be an activated period during which the UE and the SCell perform one or more communications. As shown by reference number 570, the UE may receive an SCell deactivation command. For example, the UE may receive a MAC-CE including the SCell deactivation command.

FIG. 5C is a diagram illustrating an example 500c of intermittent SSB transmission for an activated SCell, in accordance with the present disclosure. The example 500c illustrates a scenario in which an SCell is configured for intermittent SSB transmission and periodic SSB transmission. The example 500c includes a set of intermittent SSBs 510 transmitted via an SCell associated with a UE (e.g., UE 120 described in connection with FIG. 1) and a set of periodic SSBs 515 transmitted via the SCell associated with the UE and/or configured for activation by the UE. For example, the UE may detect the SCell, perform one or more actions to prepare for activation of the SCell, and/or be configured to activate the SCell for carrier aggregation. As shown by reference number 575, the UE may receive an SCell activation command. For example, the UE may receive an RRC message and/or a MAC-CE including the SCell activation command that indicates the intermittent SSBs 510 will be communicated according to a periodicity, P1. In some examples, P1 may include a time between each instance of the intermittent SSB, a time between each burst of intermittent SSBs, and/or a time between each intermittent SSB of a burst. Transition period 530c may be a transition period during which the UE and/or the SCell perform one or more procedures in association with the activation of the SCell. As shown by reference number 580, the SCell activation may be complete. The time period 585 may be an activated period during which the UE and the SCell perform one or more communications. As shown by reference number 590, the UE may receive an SCell deactivation command. For example, the UE may receive a MAC-CE including the SCell deactivation command in which the intermittent SSBs 510 are terminated. The time period 595 may be a deactivated period during which a wireless communication link between the UE and the SCell is disconnected and/or deactivated.

When and/or how a network node associated with the SCell triggers intermittent SSB transmission may be transparent to the UE, if the UE is to efficiently use resources to monitor, measure, and/or receive intermittent SSBs 510. For example, a UE may receive an indication of intermittent SSB occasions from the serving cell supporting intermittent SSB SCell operations (e.g., via a network node supporting the SCell). For example, the indication may include and/or be part of RRC-based signaling and/or and MAC-CE-based signaling.

In some examples, the deactivation of intermittent SSB transmission may be supported for a serving cell supporting intermittent SSB SCell operation. For example, intermittent SSBs 510 may be deactivated via an explicit indication (e.g., via an RRC indication, via a MAC-CE indication, via DCI). In some other examples, intermittent SSBs 510 may be deactivated via an implicit indication that may be triggered and/or based on events leading to a successful SCell activation and/or deactivation. In some other examples, intermittent SSBs may be deactivated after a threshold duration of time following a transmission (e.g., an intermittent SSB transmission, an SSB transmission).

In examples where periodic SSBs 515 may not be supported, intermittent SSBs 510 may be transmitted prior to SCell activation. In some such examples, intermittent SSBs 510 may be communicated for L3 measurement associated with a deactivated SCell and an explicit indication terminating intermittent SSB communication may not be needed. For example, intermittent SSBs 510 may be deactivated after a transmission window and/or a quantity of transmitted SSB bursts.

In some other examples, intermittent SSBs 510 may be communicated for L3 measurement associated with a deactivated SCell and/or may be communicated for L3/L1 measurement in an activated SCell. For example, if a transmission window associated with intermittent SSB transmission for L3 measurement for the deactivated SCell overlaps in time with the UE receiving an SCell activation command, the UE may identify that the intermittent SSB is transmitted until the activated SCell is deactivated. In some examples, an indication of intermittent SSBs 510 may be communicated at the same time as the SCell activation, and the SCell may transmit a new intermittent SSB indication indicating a shorter intermittent SSB periodicity for SCell activation and serving cell operations.

In some other examples, intermittent SSBs 510 may be deactivated based on transmission duration-based activation and/or implicit SCell deactivation. In examples where periodic SSBs 515 are also supported, intermittent SSB communication for L3 measurement of a deactivated SCell may be in addition to L3 measurement using periodic SSBs 515. In some other examples, L3 measurement using periodic SSBs 515 may be sufficient and intermittent SSBs 510 may not be used and/or needed. In some such examples, intermittent SSBs 510 may be used for SCell activation, however SCell activation may be similarly achieved via additional tracking reference signals for SCell activation. In some examples, intermittent SSB communications for both SCell activation and an activated SCell may be used for L3 measurement if the intermittent SSBs 510 occur during a configured SSB measurement timing configuration window. When periodic SSBs 515 and intermittent SSBs 510 are coordinated, the SSB periodicity for an SCell may be adaptable and/or configurable.

As indicated above, FIGS. 5A, 5B, and 5C are provided as examples. Other examples may differ from what is described with respect to FIGS. 5A, 5B, and 5C.

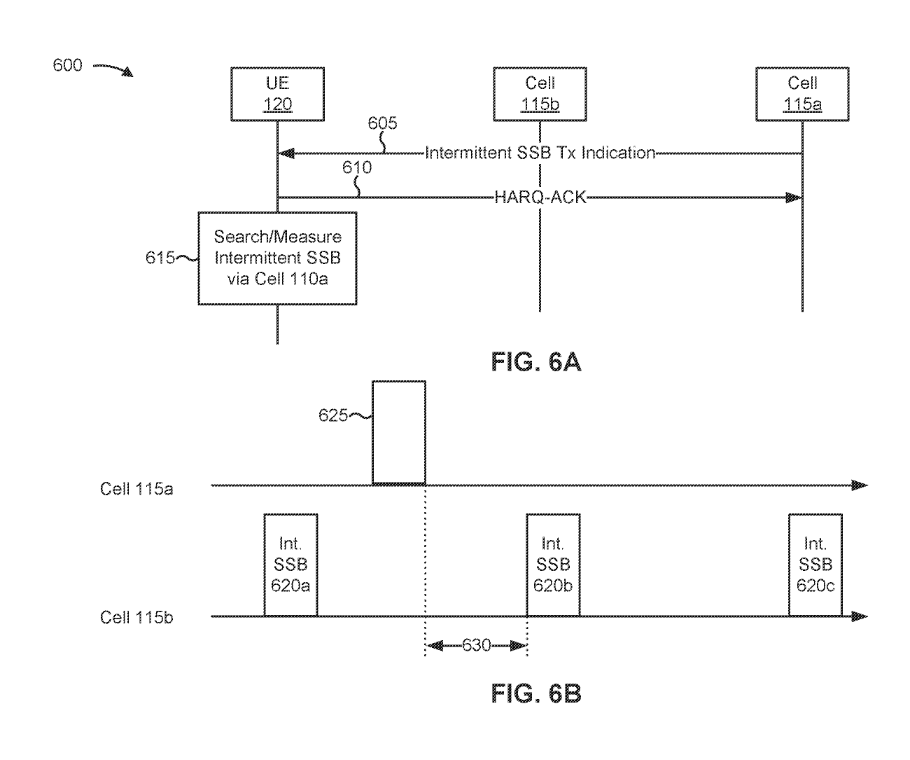

FIG. 6A is a diagram illustrating an example 600 of multi-cell signaling for intermittent SSB transmission, in accordance with the present disclosure.

In the example 600, as shown by reference number 605, a cell 115a (e.g., a PCell, or an SCell activated by and/or connected with the UE 120) may transmit (e.g., a network node supporting the cell 115a may transmit), and the UE 120 may receive, an intermittent SSB transmission indication. In response, as shown by reference number 610, the UE 120 may transmit a HARQ ACK if the UE 120 successfully receives the indication. Based on receiving the indication and/or transmitting the HARQ-ACK, as shown by reference number 615, the UE 120 may search and/or measure for intermittent SSBs communicated via a cell 115b (e.g., a yet-to-be activated SCell).

FIG. 6B is a diagram illustrating an example 605 of multi-cell signaling for intermittent SSB transmission, in accordance with the present disclosure.

According to the example 605, the intermittent SSB 620a may be transmitted via cell 115a (e.g., for another connected mode UE) before the UE 120 receives the indication of intermittent SSB transmission 625. However, from the perspective of the UE 120, the UE 120 may be informed of the intermittent SSB transmissions 620b and 620c after a time offset 630 from the indication of intermittent SSB transmission 625.

As indicated above, FIGS. 6A and 6B are provided as examples. Other examples may differ from what is described with respect to FIGS. 6A and 6B.

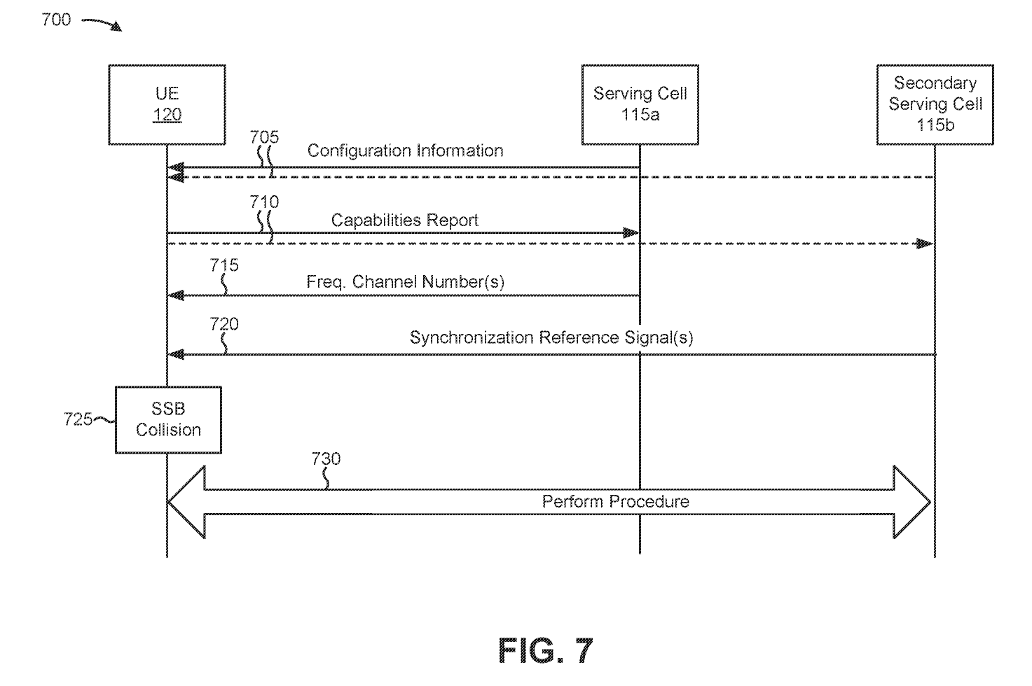

FIG. 7 is a diagram of an example 700 associated with radio frequency channel numbers for communicating on-demand SSBs using carrier aggregation, in accordance with the present disclosure. As shown in FIG. 7, the UE 120 may communicate with multiple serving cells supported by a single network node and/or multiple network nodes. The network node(s) may include one or more network nodes 110, one or more CUs, one or more DUs, one or more RUs, one or more core network nodes, one or more network servers, one or more application servers, and/or one or more access and mobility management functions (AMFs), among other examples. In some aspects, the UE, the serving cell 115a, and/or the secondary serving cell 115b may be part of a wireless network (e.g., wireless network 100). The serving cell 115a may include a primary serving cell (e.g., PCell described in connection with FIG. 4), or an additional secondary serving cell. The UE 120 and the serving cell 115a may have established a wireless connection prior to operations shown in FIG. 7.

As shown by reference number 705, the serving cell 115a and/or, in some aspects, the secondary serving cell 115b may transmit, and the UE 120 may receive, configuration information. In some aspects, the UE 120 may receive the configuration information via one or more of RRC signaling, one or more MAC-CEs, and/or DCI, among other examples. In some aspects, the configuration information may include an indication of one or more configuration parameters (e.g., already known to the UE 120 and/or previously indicated by the serving cell 115a, the secondary serving cell 115b, and/or another network device) for selection by the UE 120, and/or explicit configuration information for the UE 120 to use to configure the UE 120, among other examples.

In some aspects, the configuration information may indicate that the UE 120 is to receive one or more types of SSBs according to one or more frequency channel numbers.

In some aspects, the configuration message may include a first configuration for communicating a first type of synchronization reference signal and/or a second configuration for communicating a second type of synchronization reference signal.

The UE 120 may configure itself based at least in part on the configuration information. In some aspects, the UE 120 may be configured to perform one or more operations described herein based at least in part on the configuration information. In some aspects, the first configuration may include the first frequency channel number, and/or the second configuration may include the second frequency channel number. In some aspects, the configuration message may indicate a capability of the secondary serving cell 115b for communicating the first type of synchronization reference signal and/or a capability of the secondary serving cell 115b for communicating the second type of synchronization reference signal. For example, the configuration information may indicate that the secondary serving cell 115b is configured for communicating intermittent SSBs and periodic SSBs and/or may indicate that the secondary serving cell 115b is configured for communicating either intermittent SSBs or periodic SSBs.

As shown by reference number 710, the UE 120 may transmit, and the serving cell 115a and/or, in some aspects, the secondary serving cell 115b may receive, a capabilities report. In some aspects, the capabilities report may indicate UE support for receiving more than one type of SSB via two or more radio frequency channels.

In some aspects, the UE 120 may transmit, and the serving cell 115a and/or, in some aspects, the serving cell 115b may receive, a UE capability message indicating that the UE 120 is capable of receiving synchronization reference signals according to the first frequency channel number and/or indicating that the UE 120 is capable of receiving synchronization reference signals according to the second frequency channel number, for example, when the first frequency channel number is different than the second frequency channel number.

In some aspects, the UE capability message may indicate a respective capability for each frequency band associated with communications at the UE 120, a respective capability for each frequency band combination associated with communications at the UE 120, a respective capability for each component carrier associated with communications at the UE 120, a respective capability for each combination of frequency band and frequency band combination associated with communications at the UE 120, and/or a respective capability for each combination of frequency band, frequency band combination, and component carrier associated with communications at the UE 120.

For example, if periodic SSBs and intermittent SSBs are transmitted via two separate radio frequencies, the UE 120 may indicate a capability for supporting SSB measurement via two or more frequencies. In some aspects, the UE capability may be signaled per frequency band, per frequency band combination, per feature set (e.g., a per band per band combination capability), and/or per feature set per component carrier (e.g., a per component carrier, per band, per band combination capability).

As shown by reference number 715, the serving cell 115a may transmit, and the UE 120 may receive, one or more frequency channel numbers. For example, the serving cell 115a may transmit, and the UE 120 may receive, a first frequency channel number (e.g., ARFCN) for communicating a first type of synchronization reference signal (e.g., periodic SSB) with the secondary serving cell 115b and/or a second frequency channel number (e.g., ARFCN) for communicating a second type of synchronization reference signal (e.g., intermittent SSB) with the secondary serving cell.

In some aspects, the UE 120 may receive the one or more frequency channel numbers as part of the configuration information described in connection with reference number 705.

In some aspects, the second frequency channel number is a different frequency channel number than the first frequency channel number. In some aspects, the second frequency channel number is a same frequency channel number as the first frequency channel number. For example, the UE 120 may receive an indication of the first frequency channel number and identify that the second frequency channel number is the same as the first frequency channel number, and/or may identify that the first frequency channel number is to be used for communicating synchronization reference signals associated with the second type of synchronization reference signal. In some other aspects, the UE 120 may receive a first indication including the first frequency channel number and a second indication including the second frequency channel number. In such aspects, the second frequency channel number may be the same as or different from the first frequency channel number.

For example, the secondary serving cell 115b may be configured to communicate synchronization reference signals associated with the first type of synchronization reference signal and to communicate synchronization reference signals associated with the second type of synchronization reference signal. In such aspects, the second frequency channel number may be the same as the first frequency channel number.

As shown by reference number 720, the secondary serving cell 115b may transmit, and the UE 120 may receive, one or more synchronization reference signals. For example, the secondary serving cell 115b may transmit, and the UE 120 may receive, one or more synchronization reference signals (e.g., SSBs) associated with the first type of synchronization reference signal (e.g., periodic SSBs) and/or the second type of synchronization reference signal (e.g., intermittent SSBs) according to the first frequency channel number and/or the second frequency channel number.

In some aspects, receiving the one or more synchronization reference signals may be associated with at least one of the first type of synchronization reference signal or the second type of synchronization reference signal, in accordance with the configuration message described in connection with reference number 705.

In some aspects, an active bandwidth part associated with the secondary serving cell 115b may include a first set of one or more frequency resources for communicating the first type of synchronization reference signal according to the first frequency channel number and/or may include a second set of one or more frequency resources for communicating the second type of synchronization reference signal according to the second frequency channel number. In such aspects, the secondary cell 115b may transmit, and the UE 120 may receive, via the first set of one or more frequency resources from the secondary serving cell, one or more synchronization reference signals associated with the first type of synchronization reference signal, and/or the UE 120 may receive, via the second set of one or more frequency resources from the secondary serving cell, one or more synchronization reference signals associated with the second type of synchronization reference signals.

In some aspects, the secondary serving cell 115b may be configured for communicating synchronization reference signals associated with the second type of synchronization reference signal and/or may be precluded from communicating synchronization reference signals associated with the first type of synchronization reference signal. In such aspects, the secondary serving cell 115b may transmit, and the UE 120 may receive, one or more synchronization reference signals associated with the second type of synchronization reference signal according to the first frequency channel number.

In some aspects, the configuration information described in connection with reference number 705 may include an indication of a periodicity associated with receiving the one or more synchronization reference signals according to the second frequency channel number, where the first frequency channel number is the same as the second frequency channel number. In some other aspects, the serving cell 115a may transmit, and the UE 120 may receive, in an additional control message, an indication of the periodicity. In either aspect, the secondary serving cell 115b may transmit, and the UE 120 may receive, according to the second frequency channel number and from the secondary serving cell, one or more synchronization reference signals associated with the first type of synchronization reference signal and one or more synchronization reference signals associated with the second type of synchronization reference signal, according to the periodicity. Additionally or alternatively, the indication of the periodicity may include a plurality of periodicities, and the serving cell 115a may transmit, and the UE 120 may receive (e.g., in addition to or as part of the configuration information described in connection with reference number 705), a control message indicating the periodicity of the plurality of periodicities.

For example, for a cell supporting on-demand SSB SCell operation (e.g., secondary serving cell 115b), multiple candidate periodicity values may be configured via RRC signaling (e.g., from the serving cell 115a) and an applicable value may be indicated via MAC-CE (e.g., from the serving cell 115a and/or the secondary serving cell 115b) for intermittent SSB transmission indication via the cell (e.g., secondary serving cell 115b).

In some aspects, the configuration information described in connection with reference number 705 may include an indication of one or more transmission powers associated with the second type of synchronization reference signal. In some other aspects, the serving cell 115a may transmit, and the UE 120 may receive, in an additional control message, an indication of the one or more transmission powers. Additionally or alternatively, the serving cell 115a may transmit, and the UE 120 may receive (e.g., in addition to or as part of the configuration information described in connection with reference number 705), a control message indicating a transmission power, of the one or more transmission powers, associated with receiving one or more synchronization reference signals associated with the second type of synchronization reference signal. In such aspects, the secondary serving cell 115b may transmit, and the UE 120 may receive, one or more synchronization reference signals associated with the second type of synchronization reference signal according to the indicated transmission power.

In some aspects, the configuration information described in connection with reference number 705 may include an indication of one or more transmission powers associated with the first type of synchronization reference signal and the second type of synchronization reference signal. In some other aspects, the serving cell 115a may transmit, and the UE 120 may receive, in an additional control message, an indication of the one or more transmission powers. For example, a transmitted power indication (e.g., ss-PBCH-BlockPower) for periodic SSBs and intermittent SSBs may be transmitted via a same indication.

In some aspects, the configuration information described in connection with reference number 705 may include an indication of a set of time-frequency resources associated with a set of synchronization reference signals to be communicated with the secondary serving cell, where the one or more synchronization reference signals include the set of synchronization reference signals. In some other aspects, the serving cell 115a may transmit, and the UE 120 may receive, in an additional control message, an indication of the set of time-frequency resources. In such aspects, the UE 120 may receive, via a first set of time resources, one or more synchronization reference signals associated with the first type of synchronization reference signal, and/or may receive, via a second set of time resources, one or more synchronization reference signals associated with the second type of synchronization reference signal, where each resource of the second set of time resources is offset from a resource of the first set of time resources by a time offset. For example, the UE 120 may receive an indication of actually transmitted SSBs indicating SSB time-frequency resource positions within an intermittent SSB burst (e.g., ssb-PositionsInBurst), which may support spatial domain adaptation for intermittent SSBs.

In some aspects, the second frequency channel number may be the same as the first frequency channel number. In such aspects, the secondary serving cell 115b may transmit, and the UE 120 may receive, via a first set of time resources, one or more synchronization reference signals associated with the first type of synchronization reference signal, and via a second set of time resources, one or more synchronization reference signals associated with the second type of synchronization reference signal, where each resource of the second set of time resources is offset from a resource of the first set of time resources by a time offset. For example, the UE 120 may expect that intermittent SSBs are transmitted with a time offset from periodic SSBs, such that intermittent SSBs do not overlap in time with periodic SSBs. In some aspects, the time offset may be associated with at least one of the first set of time resources, the secondary serving cell, or a time resource identifier of a first occurring time resource associated with the secondary serving cell. For example, the timing offset may be based on the time locations of periodic SSBs via the secondary serving cell 115b, or a first system frame number of the secondary serving cell 115b.

As shown by reference number 725, at least one synchronization reference signal associated with the second type of synchronization reference signal may collide with at least one synchronization reference signal associated with the first type of synchronization reference signal. For example, as described in connection with reference number 720, the secondary serving cell 115b may transmit, and the UE 120 may receive, according to the first frequency channel number, one or more synchronization reference signals associated with the first type of synchronization reference signal, and may receive, according to the second frequency channel number, one or more synchronization reference signals associated with the second type of synchronization reference signal, where at least one synchronization reference signal associated with the second type of synchronization reference signal at least partially overlaps in time and frequency with at least one synchronization reference signal associated with the first type of synchronization reference signal. In such aspects, the UE 120 may identify an error and/or an error case associated with receiving at least one of the one or more synchronization reference signals associated with the first type of synchronization reference signal or the one or more synchronization reference signals associated with the second type of synchronization reference signal.

As shown by reference number 730, the UE 120 and/or the secondary serving cell 115b may perform a procedure (e.g., an initial access procedure, an activation procedure, a connection procedure). For example, the UE 120 and/or the secondary serving cell 115b may perform a CSI measurement procedure. In such aspects, the CSI measurement procedure may include aspects of measuring characteristics of the wireless connection between the UE 120 and the secondary cell 115b.

In some aspects, the UE 120 and/or the secondary serving cell 115b may perform a CSI reporting procedure. In such aspects, the CSI reporting procedure may include aspects of periodically and/or aperiodically communicating a CSI report. In some aspects, the UE 120 and/or the secondary serving cell 115b may perform a beam management procedure. In such aspects, the beam management procedure may include aspects of beam sweeping, beam measurement, beam reporting, beam selection, beam refinement, beam recovery, and/or beam switching. In some aspects, the UE 120 and/or the secondary serving cell 115b may perform an RLM procedure. In such aspects, an RLM procedure may include radio link quality measurement, radio link failure detection, radio link characteristic reporting, and/or radio link failure recovery actions. In some aspects, the UE 120 and/or the secondary serving cell 115b may perform an uplink power control procedure. In such aspects, an uplink power control procedure may include adjusting an uplink power level, an open loop power control procedure, and/or a closed loop power control procedure. In some aspects, the UE 120 and/or the secondary serving cell 115b may perform a mobility management procedure. In such aspects, the mobility management procedure may include aspects of tracking a location of the UE 120, maintaining a connection between the UE 120 and the secondary cell 115b, and/or performing a handover procedure. In some aspects, the UE 120 and/or the secondary serving cell 115b may perform a procedure (e.g., an initial access procedure, an activation procedure, a connection procedure) using the one or more synchronization reference signals associated with the first type of synchronization reference signal, the one or more synchronization reference signals associated with the second type of synchronization reference signal, or both.

In some aspects, the secondary serving cell 115b may be configured for communicating synchronization reference signals associated with the second type of synchronization reference signal and an active bandwidth part associated with the secondary serving cell may include a set of one or more frequency resources, according to the second frequency channel number, for communicating the second type of synchronization reference signal. In such aspects, the UE 120 and/or the secondary serving cell 115b may perform a procedure (e.g., an access procedure) associated with the second type of synchronization reference signal in association with receiving one or more synchronization reference signals associated with the second type of synchronization reference signal.

In some aspects, as described in connection with reference number 720, the secondary serving cell 115b may transmit, and the UE 120 may receive, according to the first frequency channel number, one or more synchronization reference signals associated with the first type of synchronization reference signal, and may receive, according to the second frequency channel number, one or more synchronization reference signals associated with the second type of synchronization reference signal, where at least one synchronization reference signal associated with the second type of synchronization reference signal fully overlaps in time and frequency with at least one synchronization reference signal associated with the first type of synchronization reference signal. In such aspects, the UE 120 and/or the secondary serving cell 115b may perform a procedure, such as an initial access procedure, using the at least one synchronization reference signal associated with the first type of synchronization reference signal, and/or using the at least one synchronization reference signal associated with the second type of synchronization reference signal.

As indicated above, FIG. 7 is provided as an example. Other examples may differ from what is described with respect to FIG. 7.

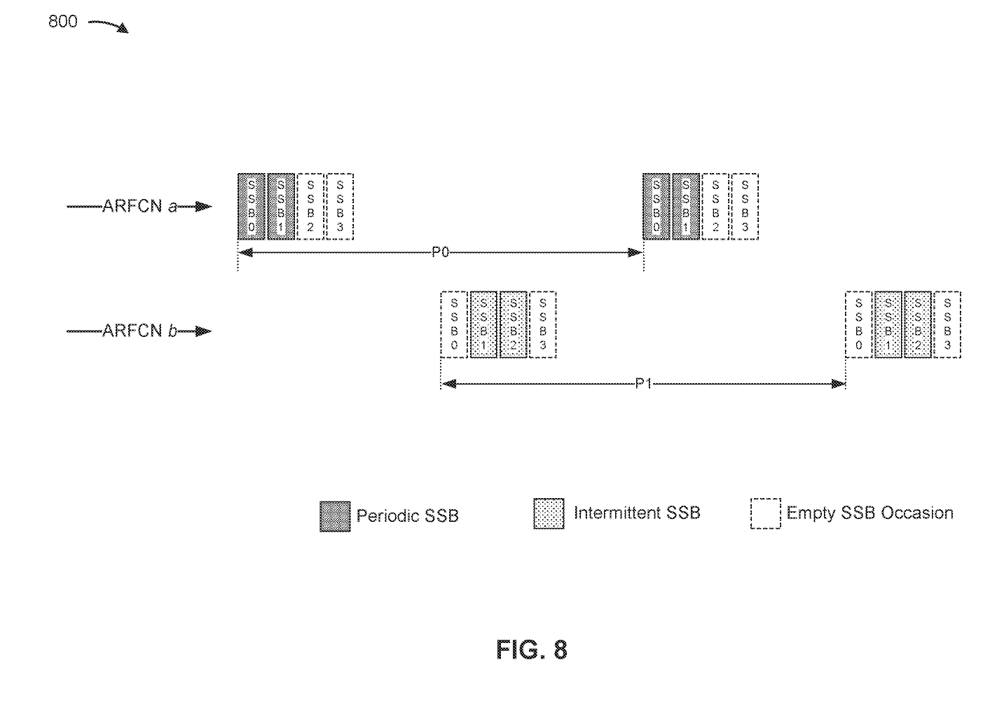

FIG. 8 is a diagram illustrating an example 800 associated with periodic SSB and intermittent SSB transmission via separate radio frequencies, in accordance with the present disclosure. Example 800 illustrates communications via a secondary serving cell that is configured to communicate periodic CD-SSBs and intermittent NCD-SSBs. In such aspects, a network node associated with an SCell may transmit each type of SSB via a separate frequency. The network node may transmit periodic SSBs via a synchronization raster frequency(ies) (e.g., absoluteFrequencySSB) indicated to a UE by a downlink configuration message (e.g., DownlinkConfigCommon) and may transmit intermittent SSBs via a frequency that is not indicated by the downlink configuration message (e.g., is different from the synchronization raster frequency(ies) sync raster (i.e., in frequency(ies) indicated by a new RRC parameter). For example, a UE may receive, via the SCell, periodic SSBs according to a frequency channel number, absolute radio frequency channel number (ARFCN) a at a first burst periodicity, P0, and may receive, via the SCell, intermittent SSBs according to a frequency channel number, ARFCN b at a second burst periodicity, P1. In such examples, the secondary serving cell may not support initial cell selection but may support cell reselection based on the periodic SSBs. However, if both the periodic SSBs and the intermittent SSBs are configured for a particular procedure (e.g., L1/L3 measurement, radio link management or beam management), the UE may track the SSBs in two separate frequencies, which may prompt the UE to perform additional radio frequency retuning and/or may contradict some existing communication protocols in which the SSBs configured for a particular procedure are defined as occurring via the same frequency. In the context of carrier aggregation, if a UE were to track the SSBs in two separate frequencies for each SCell, UE complexity may significantly increase, because multiple SCells may communicate a combination of periodic CD-SSBs and/or intermittent NCD-SSBs.

In some aspects, the intermittent SSBs may be transmitted within the active downlink BWP of the cell supporting intermittent SSB operation. For example, the UE may be informed and/or assume that intermittent SSBs are transmitted within an active downlink BWP of the SCell supporting intermittent SSB operations, for example, when intermittent SSBs are configured for a particular PHY procedure.

In some other aspects, when both periodic SSBs and intermittent SSBs are transmitted within an active downlink BWP, for performing PHY procedures (e.g., beam management, RLM, uplink power control), the UE may select a type of SSB and/or may use both types of SSBs for search, measurement, and/or synchronization. For example, when both periodic SSBs and intermittent SSBs are transmitted within the active downlink BWP of the UE, for performing one or more PHY procedures, such as beam management, RLM, uplink power control, among other examples, the UE may use (e.g., search for, monitor for, measure, synchronize using, receive, among other examples) both SSB types (e.g., periodic SSBs, and intermittent SSBs) for SCell activation.

In some other aspects, when both periodic SSBs and intermittent SSBs are transmitted within the active downlink BWP of the UE, for performing one or more PHY procedures, such as beam management, RLM, uplink power control, among other examples, the UE may determine to use (e.g., search for, monitor for, measure, synchronize using, receive, among other examples) one of the SSB types (e.g., periodic SSB, or intermittent SSB, or both) based on a configuration of the network node supporting the SCell. In some aspects, the network node may transmit, and the UE may receive, the configuration via RRC signaling, MAC-CE signaling, and/or DCI.

When periodic SSBs and intermittent SSBs are transmitted via two separate radio frequencies, the UE may indicate a UE capability for measuring SSBs via two frequencies. In some aspects, the UE capability may be signaled per-band, per-band combination or per-feature set (e.g., per-band, per-band combination), or per-feature set per-component carrier set (e.g., per-component carrier, per-band, per-band combination).

When the frequency via which the intermittent SSBs are transmitted (e.g., a frequency channel number of the intermittent SSBs) is identical to the frequency via which the periodic SSBs are transmitted (e.g., a frequency channel number of the periodic SSBs), then when the intermittent SSBs are transmitted (e.g., at a time offset T (e.g., slots) after the UE receives the indication of intermittent SSB transmission), the combination of periodic SSB transmissions and intermittent SSB transmissions may adhere to a periodic transmission schedule according to a periodicity that is indicated for intermittent SSBs.

Intermittent SSB transmission (e.g., via the same frequencies as, or different frequencies than, periodic SSB transmission) may be adapted based on a periodicity of the intermittent SSBs (e.g., time domain adaptation). For a cell supporting intermittent SSB SCell operation, multiple candidate values may be configured by control signaling (e.g., RRC signaling) and an applicable value (e.g., a value applicable to an actual SSB transmission) may be indicated via control information (e.g., MAC-CE) for intermittent SSB transmissions. In some aspects, the candidate values, and/or the applicable value may be indicated via an intermittent SSB transmission indication (e.g., an indication of intermittent SSB transmission 625 described in connection with FIG. 6).

As indicated above, FIG. 8 is provided as an example. Other examples may differ from what is described with respect to FIG. 8.

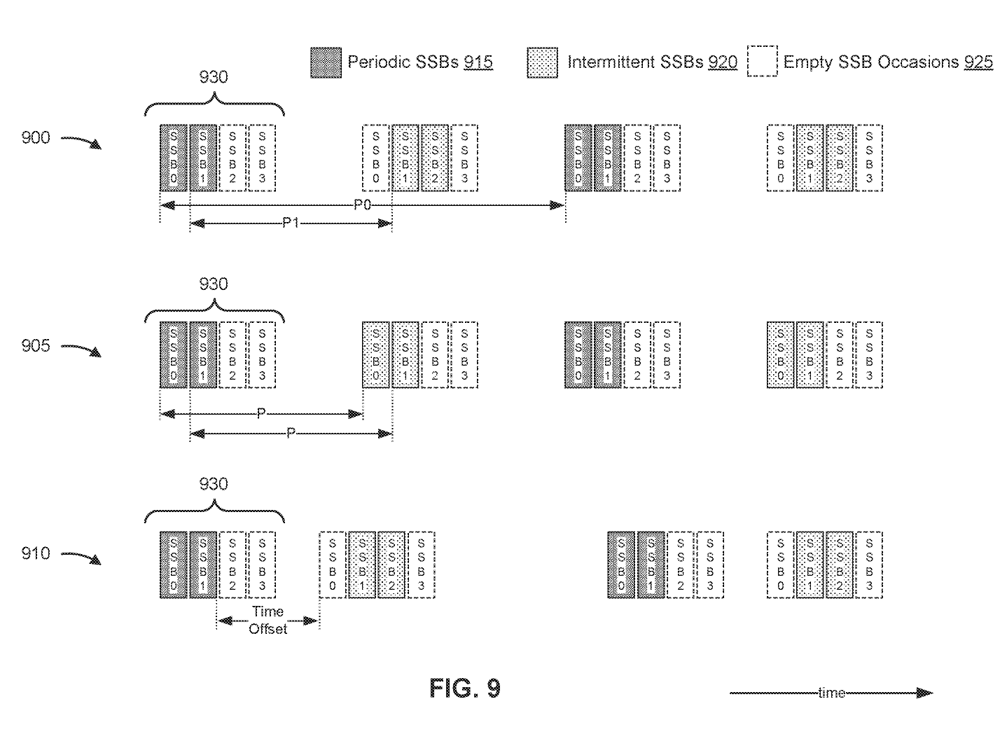

FIG. 9 is a diagram illustrating examples 900, 905, and 910 associated with spatial domain adaptation for intermittent SSBs, in accordance with the present disclosure. Examples 900, 905, and 910 each include periodic SSBs 915, intermittent SSBs 920, and empty SSB occasions 925. Empty SSB occasions 925 illustrate time and/or frequency resources via which an SSB may be allocated resources and/or scheduled to be transmitted (e.g., as part of an SSB burst 930) but is not transmitted. For example, an indication of actually transmitted SSBs may include SSB positions and/or time/frequency occasions within an SSB burst 930 (e.g., ssb-PositionsInBurst) as related to spatial domain adaptation for SSB transmission. The examples 900, 905, and 910 illustrate scenarios in which periodic SSBs 915 and intermittent SSBs 920 are communicated via the same radio frequency (e.g., are transmitted according to a same ARFCN).

In some aspects, when periodic SSBs 915 and intermittent SSBs 920 are transmitted via the same radio frequency, spatial domain adaptation for intermittent SSBs 920 may create a deployment including non-uniform SSB transmission, as illustrated in example 900. In the example 900, SSBs may be transmitted at different periodicities. For example, SSB0 may be transmitted at a period P0, and SSB1 may be transmitted at a periodicity of P1 which may be smaller than P0.

Example 905 illustrates an alternative where the combination of periodic SSBs 915 and intermittent SSBs 920 are transmitted according to a periodicity P. In some aspects, a UE may receive an indication of P for intermittent SSBs 920 and may apply the periodicity, and/or extrapolate that the periodicity applies, to the periodic SSBs 915 in combination with the intermittent SSBs 920. In some aspects, a UE may receive an indication of which SSB occasions and/or which SSBs are transmitted (e.g., as an alternative to assuming that an SSB may be transmitted in each occasion), and in the example 905, indications of transmitted periodic SSBs 915 and transmitted intermittent SSBs 920 may be identical (e.g., may indicate that the same occasions in an SSB burst 930 are not used for SSB communication).

Example 910 illustrates another alternative to example 900, where intermittent SSBs 920 are transmitted at a time offset from the transmission of periodic SSBs 915 in such a way that intermittent SSBs 920 do not overlap in time with periodic SSBs 915. As a result, the periodicity of intermittent SSBs 920 may be decoupled from the periodicity of periodic SSBs 915.

In some aspects, a transmission power of intermittent SSBs 920 (e.g., as indicated by ss-PBCH-BlockPower) may be adapted in the power domain, where ss-PBCH-BlockPower is an average energy per resource element (e.g., in decibel-milliwatts) of the resource elements including SSSs used for SSB transmission (e.g., transmitted by a network node). Power domain adaptation for intermittent SSBs 920 may similarly create a deployment with non-uniform SSB transmission power (e.g., each SSB burst 930 may be transmitted with a different power) (e.g., similar to example 900). In such aspects, a UE may receive an indication of the transmit power associated with periodic SSBs 915 and an indication of the transmit power of intermittent SSBs 920.

If the frequency via which intermittent SSBs 920 are transmitted (e.g., ARFCN) is identical to the frequency via which periodic SSBs 915 are transmitted, then a frequency parameter, such as absoluteFrequencySSB provided in downlink control information, such as DownlinkConfigCommon, may be used for both periodic SSBs 915 and intermittent SSBs 920 (e.g., an additional RRC parameter to indicate absolute frequency (e.g., in terms of ARFCN) of intermittent SSBs 920 may be obsolete and/or not needed).

As shown in the example 905, the combination of periodic SSBs 915 and intermittent SSBs 920 may be transmitted according to a periodicity indicated for intermittent SSBs 920. Additionally or alternatively, indications of actually transmitted SSBs (e.g., or indications of empty SSB occasions 925) and transmit power (e.g., ss-PBCH-BlockPower) for periodic SSBs 915 and intermittent SSBs 920 may be identical.

As shown in the example 910, intermittent SSBs 920 (e.g., intermittent SSB bursts) may be transmitted according to a time offset from the transmission of periodic SSBs 915 such that intermittent SSBs 920 do not overlap in time with periodic SSBs 915. In such aspects, the reference for the timing offset may be based on the time resources of periodic SSBs 915 associated with an SCell or an SFN0 of the SCell.

In some aspects, intermittent SSBs 920 and periodic SSBs 915 may collide, in which case periodic SSBs 915 and intermittent SSBs 920 may fully overlap during a colliding occasion. However, a partial collision of an intermittent SSB 920 and a periodic SSB 915 may be prohibited.

In the scenario where an SCell supports intermittent SSBs 920 and does not support periodic SSBs 915, a frequency parameter, such as absoluteFrequencySSB communicated via downlink control information, such as DownlinkConfigCommon, may be used for the transmission of intermittent SSBs 920.

As indicated above, FIG. 9 is provided as an example. Other examples may differ from what is described with respect to FIG. 9.

FIG. 10 is a diagram illustrating an example process 1000 performed, for example, at a UE or an apparatus of a UE, in accordance with the present disclosure. Example process 1000 is an example where the apparatus or the UE (e.g., UE 120) performs operations associated with radio frequency channel numbers for communicating on-demand SSBs using carrier aggregation.

As shown in FIG. 10, in some aspects, process 1000 may include receiving, via a serving cell, at least one of a first frequency channel number for communicating a first type of synchronization reference signal with a secondary serving cell or a second frequency channel number for communicating a second type of synchronization reference signal with the secondary serving cell (block 1010). For example, the UE (e.g., using reception component 1302 and/or communication manager 1306, depicted in FIG. 13) may receive, via a serving cell, at least one of a first frequency channel number for communicating a first type of synchronization reference signal with a secondary serving cell or a second frequency channel number for communicating a second type of synchronization reference signal with the secondary serving cell, as described above.

As further shown in FIG. 10, in some aspects, process 1000 may include receiving one or more synchronization reference signals associated with at least one of the first type of synchronization reference signal or the second type of synchronization reference signal according to at least one of the first frequency channel number or the second frequency channel number (block 1020). For example, the UE (e.g., using reception component 1302 and/or communication manager 1306, depicted in FIG. 13) may receive one or more synchronization reference signals associated with at least one of the first type of synchronization reference signal or the second type of synchronization reference signal according to at least one of the first frequency channel number or the second frequency channel number, as described above.

Process 1000 may include additional aspects, such as any single aspect or any combination of aspects described below and/or in connection with one or more other processes described elsewhere herein.

In a first aspect, the second frequency channel number is a same frequency channel number as the first frequency channel number.

In a second aspect, alone or in combination with the first aspect, the second frequency channel number is a different frequency channel number than the first frequency channel number.

In a third aspect, alone or in combination with one or more of the first and second aspects, the serving cell includes at least one of a primary serving cell, or an additional secondary serving cell.

In a fourth aspect, alone or in combination with one or more of the first through third aspects, the secondary serving cell is configured for communicating synchronization reference signals associated with the second type of synchronization reference signal, and an active bandwidth part associated with the secondary serving cell includes a set of one or more frequency resources, according to the second frequency channel number, for communicating the second type of synchronization reference signal.

In a fifth aspect, alone or in combination with one or more of the first through fourth aspects, process 1000 includes performing a procedure associated with the second type of synchronization reference signal in association with receiving one or more synchronization reference signals associated with the second type of synchronization reference signal.

In a sixth aspect, alone or in combination with one or more of the first through fifth aspects, an active bandwidth part associated with the secondary serving cell includes a first set of one or more frequency resources for communicating the first type of synchronization reference signal according to the first frequency channel number and includes a second set of one or more frequency resources for communicating the second type of synchronization reference signal according to the second frequency channel number.

In a seventh aspect, alone or in combination with one or more of the first through sixth aspects, process 1000 includes receiving, via the first set of one or more frequency resources from the secondary serving cell, one or more synchronization reference signals associated with the first type of synchronization reference signal, receiving, via the second set of one or more frequency resources from the secondary serving cell, one or more synchronization reference signals associated with the second type of synchronization reference signal, and performing a procedure, with the secondary serving cell, using the one or more synchronization reference signals associated with the first type of synchronization reference signal, the one or more synchronization reference signals associated with the second type of synchronization reference signal, or both.

In an eighth aspect, alone or in combination with one or more of the first through seventh aspects, the procedure includes at least one of a CSI measurement procedure, a CSI reporting procedure, a beam management procedure, an RLM procedure, an uplink power control procedure, or a mobility management procedure.

In an ninth aspect, alone or in combination with one or more of the first through eighth aspects, the secondary serving cell is configured for communicating synchronization reference signals associated with the second type of synchronization reference signal and is precluded from communicating synchronization reference signals associated with the first type of synchronization reference signal, and receiving the one or more synchronization reference signals comprises receiving one or more synchronization reference signals associated with the second type of synchronization reference signal according to the first frequency channel number.

In a tenth, alone or in combination with one or more of the first through ninth aspects, the secondary serving cell is configured for communicating synchronization reference signals associated with the second type of synchronization reference signal and is precluded from communicating synchronization reference signals associated with the first type of synchronization reference signal, and receiving the one or more synchronization reference signals includes refraining from monitoring a frequency channel associated with the first frequency channel number.

In an eleventh aspect, alone or in combination with one or more of the first through tenth aspects, the secondary serving cell is configured to communicate synchronization reference signals associated with the first type of synchronization reference signal and to communicate synchronization reference signals associated with the second type of synchronization reference signal, and the second frequency channel number is a same frequency channel number as the first frequency channel number.

In a twelfth aspect, alone or in combination with one or more of the first through eleventh aspects, process 1000 includes receiving a configuration message, associated with the secondary serving cell, including at least one of a first configuration for communicating the first type of synchronization reference signal or a second configuration for communicating the second type of synchronization reference signal, wherein receiving the one or more synchronization reference signals associated with at least one of the first type of synchronization reference signal or the second type of synchronization reference signal is in accordance with the configuration message.

In an thirteenth aspect, alone or in combination with one or more of the first through twelfth aspects, the first configuration includes the first frequency channel number, and the second configuration includes the second frequency channel number.

In a fourteenth aspect, alone or in combination with one or more of the first through thirteenth aspects, the configuration message indicates a capability of the secondary serving cell for communicating the first type of synchronization reference signal and a capability of the secondary serving cell for communicating the second type of synchronization reference signal.

In a fifteenth aspect, alone or in combination with one or more of the first through fourteenth aspects, receiving the configuration message comprises receiving at least one of a radio resource control message, a medium access control message, or a downlink control message.

In a sixteenth aspect, alone or in combination with one or more of the first through fifteenth aspects, process 1000 includes transmitting a UE capability message indicating that the UE is capable of receiving synchronization reference signals according to the first frequency channel number and indicating that the UE is capable of receiving synchronization reference signals according to the second frequency channel number, wherein the first frequency channel number is different than the second frequency channel number.

In a seventeenth aspect, alone or in combination with one or more of the first through sixteenth aspects, the UE capability message indicates at least one of a respective capability of the UE, a respective capability for each frequency band associated with communications at the UE, a respective capability for each frequency band combination associated with communications at the UE, a respective capability for each component carrier associated with communications at the UE, a respective capability for each combination of frequency band and frequency band combination associated with communications at the UE, or a respective capability for each combination of frequency band, frequency band combination, and component carrier associated with communications at the UE.

In an eighteenth aspect, alone or in combination with one or more of the first through seventeenth aspects, process 1000 includes receiving an indication of a periodicity associated with receiving the one or more synchronization reference signals according to the second frequency channel number, wherein the first frequency channel number is a same frequency channel number as the second frequency channel number.

In a nineteenth aspect, alone or in combination with one or more of the first through eighteenth aspects, process 1000 includes receiving, according to the second frequency channel number and from the secondary serving cell, one or more synchronization reference signals associated with the first type of synchronization reference signal and one or more synchronization reference signals associated with the second type of synchronization reference signal according to the periodicity.

In a twentieth aspect, alone or in combination with one or more of the first through nineteenth aspects, the indication of the periodicity includes a plurality of periodicities, the method further comprising receiving a control message indicating the periodicity of the plurality of periodicities.

In a twenty-first aspect, alone or in combination with one or more of the first through twentieth aspects, process 1000 includes receiving an indication of one or more transmission powers associated with the second type of synchronization reference signal.

In a twenty-second aspect, alone or in combination with one or more of the first through twenty-first aspects, process 1000 includes receiving a control message indicating a transmission power, of the one or more transmission powers, associated with receiving one or more synchronization reference signals associated with the second type of synchronization reference signal.

In a twenty-third aspect, alone or in combination with one or more of the first through twenty-second aspects, process 1000 includes receiving an indication of one or more transmission powers associated with the first type of synchronization reference signal and the second type of synchronization reference signal.

In a twenty-fourth aspect, alone or in combination with one or more of the first through twenty-third aspects, process 1000 includes receiving an indication of a set of time-frequency resources associated with a set of synchronization reference signals to be communicated with the secondary serving cell, wherein the one or more synchronization reference signals include the set of synchronization reference signals.

In a twenty-fifth aspect, alone or in combination with one or more of the first through twenty-fourth aspects, receiving the one or more synchronization reference signals comprises receiving, via a first set of time resources, one or more synchronization reference signals associated with the first type of synchronization reference signal, and receiving, via a second set of time resources, one or more synchronization reference signals associated with the second type of synchronization reference signal, wherein each resource of the second set of time resources is offset from a resource of the first set of time resources by a time offset.

In a twenty-sixth aspect, alone or in combination with one or more of the first through twenty-fifth aspects, the time offset is associated with at least one of the first set of time resources, the secondary serving cell, or a time resource identifier of a first occurring time resource associated with the secondary serving cell.

In a twenty-seventh aspect, alone or in combination with one or more of the first through twenty-sixth aspects, process 1000 includes receiving, according to the first frequency channel number, one or more synchronization reference signals associated with the first type of synchronization reference signal, receiving, according to the second frequency channel number, one or more synchronization reference signals associated with the second type of synchronization reference signal, wherein at least one synchronization reference signal associated with the second type of synchronization reference signal at least partially overlaps in time and frequency with at least one synchronization reference signal associated with the first type of synchronization reference signal, and identifying an error associated with receiving at least one of the one or more synchronization reference signals associated with the first type of synchronization reference signal or the one or more synchronization reference signals associated with the second type of synchronization reference signal.

In a twenty-eighth aspect, alone or in combination with one or more of the first through twenty-seventh aspects, process 1000 includes receiving, according to the first frequency channel number, one or more synchronization reference signals associated with the first type of synchronization reference signal, receiving, according to the second frequency channel number, one or more synchronization reference signals associated with the second type of synchronization reference signal wherein at least one synchronization reference signal associated with the second type of synchronization reference signal fully overlaps in time and frequency with at least one synchronization reference signal associated with the first type of synchronization reference signal, and performing a procedure, with the secondary serving cell, using the at least one synchronization reference signal associated with the first type of synchronization reference signal, or using the at least one synchronization reference signal associated with the second type of synchronization reference signal.

In a twenty-ninth aspect, alone or in combination with one or more of the first through twenty-eighth aspects, process 1000 includes receiving a first transmit power indication associated with the first type of synchronization reference signal; and receiving a second transmit power indication, associated with the second type of synchronization reference signal, that is the same as the first transmit power indication.

In a thirtieth aspect, alone or in combination with one or more of the first through twenty-nineth aspects, process 1000 includes receiving a first burst position indication associated with the first type of synchronization reference signal and receiving a second burst position indication, associated with the second type of synchronization reference signal, that is the same as the first burst position indication.

In a thirty-first aspect, alone or in combination with one or more of the first through thirtieth aspects, process 1000 includes transmitting a capability message that indicates UE support for receiving a first transmit power indication associated with the first type of synchronization reference signal and for receiving a second transmit power indication, associated with the second type of synchronization reference signal, that is different from the first transmit power indication.

In a thirty-second aspect, alone or in combination with one or more of the first through thirty-first aspects, process 1000 includes transmitting a capability message that indicates UE support for receiving a first burst position indication associated with the first type of synchronization reference signal and for receiving a second burst position indication, associated with the second type of synchronization reference signal, that is different from the first burst position indication.

In a thirty-third aspect, alone or in combination with one or more of the first through thirty-second aspects, the second type of synchronization reference signal is deactivated after a threshold duration of time.

In a thirty-fourth aspect, alone or in combination with one or more of the first through thirty-third aspects, the second type of synchronization reference signal is deactivated in association with a deactivation of the secondary serving cell.

In a thirty-fifth aspect, alone or in combination with one or more of the first through thirty-fourth aspects, the process 1000 includes receiving a quantity of synchronization reference signal bursts, wherein the second type of synchronization reference signal is deactivated in accordance with the quantity of synchronization reference signal bursts satisfying a threshold.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network node or an apparatus of a network node, in accordance with the present disclosure. Example process 1100 is an example where the apparatus or the network node (e.g., network node 110) performs operations associated with radio frequency channel numbers for communicating on-demand SSBs using carrier aggregation.

As shown in FIG. 11, in some aspects, process 1100 may include transmitting, to a UE, one or more synchronization reference signals associated with at least one of a first type of synchronization reference signal or a second type of synchronization reference signal according to at least one of a first frequency channel number for communicating the first type of synchronization reference signal or the second frequency channel number for communicating a second type of synchronization reference signal (block 1110). For example, the network node (e.g., using transmission component 1404 and/or communication manager 1406, depicted in FIG. 14) may transmit, to a UE, one or more synchronization reference signals associated with at least one of a first type of synchronization reference signal or a second type of synchronization reference signal according to at least one of a first frequency channel number for communicating the first type of synchronization reference signal or a second frequency channel number for communicating the second type of synchronization reference signal, as described above.

Process 1100 may include additional aspects, such as any single aspect or any combination of aspects described below and/or in connection with one or more other processes described elsewhere herein.

In a first aspect, the second frequency channel number is a same frequency channel number as the first frequency channel number.

In a second aspect, alone or in combination with the first aspect, the second frequency channel number is a different frequency channel number than the first frequency channel number.

In a third aspect, alone or in combination with one or more of the first and second aspects, the secondary serving cell is configured for communicating synchronization reference signals associated with the second type of synchronization reference signal, and an active bandwidth part associated with the secondary serving cell includes a set of one or more frequency resources, according to the second frequency channel number, for communicating the second type of synchronization reference signal.

In a fourth aspect, alone or in combination with one or more of the first through third aspects, process 1100 includes performing a procedure associated with the second type of synchronization reference signal in association with transmitting one or more synchronization reference signals associated with the second type of synchronization reference signal.

In a fifth aspect, alone or in combination with one or more of the first through fourth aspects, an active bandwidth part associated with the secondary serving cell includes a first set of one or more frequency resources for communicating the first type of synchronization reference signal according to the first frequency channel number and includes a second set of one or more frequency resources for communicating the second type of synchronization reference signal according to the second frequency channel number.

In a sixth aspect, alone or in combination with one or more of the first through fifth aspects, process 1100 includes transmitting, via the first set of one or more frequency resources, one or more synchronization reference signals associated with the first type of synchronization reference signal, transmitting, via the second set of one or more frequency resources, one or more synchronization reference signals associated with the second type of synchronization reference signal, and performing a procedure, with the UE using the one or more synchronization reference signals associated with the first type of synchronization reference signal, the one or more synchronization reference signals associated with the second type of synchronization reference signal, or both.

In a seventh aspect, alone or in combination with one or more of the first through sixth aspects, the procedure includes at least one of a CSI measurement procedure, a CSI reporting procedure, a beam management procedure, an RLM procedure, an uplink power control procedure, or a mobility management procedure.

In an eighth aspect, alone or in combination with one or more of the first through seventh aspects, the secondary serving cell is configured for communicating synchronization reference signals associated with the second type of synchronization reference signal and is precluded from communicating synchronization reference signals associated with the first type of synchronization reference signal, and transmitting the one or more synchronization reference signals comprises transmitting one or more synchronization reference signals associated with the second type of synchronization reference signal according to the first frequency channel number.

In a ninth aspect, alone or in combination with one or more of the first through eighth aspects, the secondary serving cell is configured to communicate synchronization reference signals associated with the first type of synchronization reference signal and to communicate synchronization reference signals associated with the second type of synchronization reference signal, and the second frequency channel number is a same frequency channel number as the first frequency channel number.

In a tenth aspect, alone or in combination with one or more of the first through ninth aspects, process 1100 includes transmitting a configuration message, associated with the secondary serving cell, including at least one of a first configuration for communicating the first type of synchronization reference signal or a second configuration for communicating the second type of synchronization reference signal, wherein transmitting the one or more synchronization reference signals associated with at least one of the first type of synchronization reference signal or the second type of synchronization reference signal is in accordance with the configuration message.

In an eleventh aspect, alone or in combination with one or more of the first through tenth aspects, the first configuration includes the first frequency channel number, and the second configuration includes the second frequency channel number.

In a twelfth aspect, alone or in combination with one or more of the first through eleventh aspects, the configuration message indicates a capability of the secondary serving cell for communicating the first type of synchronization reference signal and a capability of the secondary serving cell for communicating the second type of synchronization reference signal.

In a thirteenth aspect, alone or in combination with one or more of the first through twelfth aspects, transmitting the configuration message comprises transmitting at least one of a radio resource control message, a medium access control message, or a downlink control message.

In a fourteenth aspect, alone or in combination with one or more of the first through thirteenth aspects, process 1100 includes receiving a UE capability message indicating that the UE is capable of communicating synchronization reference signals according to the first frequency channel number and indicating that the UE is capable of communicating synchronization reference signals according to the second frequency channel number, wherein the first frequency channel number is different than the second frequency channel number.

In a fifteenth aspect, alone or in combination with one or more of the first through fourteenth aspects, the UE capability message indicates at least one of a respective capability for the UE, a respective capability for each frequency band associated with communications at the UE, a respective capability for each frequency band combination associated with communications at the UE, a respective capability for each component carrier associated with communications at the UE, a respective capability for each combination of frequency band and frequency band combination associated with communications at the UE, or a respective capability for each combination of frequency band, frequency band combination, and component carrier associated with communications at the UE.

In a sixteenth aspect, alone or in combination with one or more of the first through fifteenth aspects, process 1100 includes transmitting an indication of a periodicity associated with transmitting the one or more synchronization reference signals according to the second frequency channel number, wherein the first frequency channel number is a same frequency channel number as the second frequency channel number.

In a seventeenth aspect, alone or in combination with one or more of the first through sixteenth aspects, process 1100 includes transmitting, according to the second frequency channel number, one or more synchronization reference signals associated with the first type of synchronization reference signal and one or more synchronization reference signals associated with the second type of synchronization reference signal according to the periodicity.

In an eighteenth aspect, alone or in combination with one or more of the first through seventeenth aspects, the indication of the periodicity includes a plurality of periodicities, the method further comprising transmitting a control message indicating the periodicity of the plurality of periodicities.

In a nineteenth aspect, alone or in combination with one or more of the first through eighteenth aspects, process 1100 includes transmitting an indication of one or more transmission powers associated with the second type of synchronization reference signal.

In a twentieth aspect, alone or in combination with one or more of the first through nineteenth aspects, process 1100 includes transmitting a control message indicating a transmission power, of the one or more transmission powers, associated with transmitting one or more synchronization reference signals associated with the second type of synchronization reference signal.

In a twenty-first aspect, alone or in combination with one or more of the first through twentieth aspects, process 1100 includes transmitting an indication of one or more transmission powers associated with the first type of synchronization reference signal and the second type of synchronization reference signal.

In a twenty-second aspect, alone or in combination with one or more of the first through twenty-first aspects, process 1100 includes transmitting an indication of a set of time-frequency resources associated with a set of synchronization reference signals to be communicated with the secondary serving cell, wherein the one or more synchronization reference signals include the set of synchronization reference signals.

n a twenty-third aspect, alone or in combination with one or more of the first through twenty-second aspects, transmitting the one or more synchronization reference signals comprises transmitting, via a first set of time resources, one or more synchronization reference signals associated with the first type of synchronization reference signal, and transmitting, via a second set of time resources, one or more synchronization reference signals associated with the second type of synchronization reference signal, wherein each resource of the second set of time resources is offset from a resource of the first set of time resources by a time offset.

In a twenty-fourth aspect, alone or in combination with one or more of the first through twenty-third aspects, the time offset is associated with at least one of the first set of time resources, the secondary serving cell, or a time resource identifier of a first occurring time resource associated with the secondary serving cell.

In a twenty-fifth aspect, alone or in combination with one or more of the first through twenty-fourth aspects, process 1100 includes transmitting, according to the first frequency channel number, one or more synchronization reference signals associated with the first type of synchronization reference signal, refraining from transmitting, according to the second frequency channel number, at least one synchronization reference signal associated with the second type of synchronization reference signal that at least partially overlaps in time and frequency with at least one synchronization reference signal associated with the first type of synchronization reference signal.

In a twenty-sixth aspect, alone or in combination with one or more of the first through twenty-fifth aspects, process 1100 includes transmitting, according to the first frequency channel number, one or more synchronization reference signals associated with the first type of synchronization reference signal, transmitting, according to the second frequency channel number, one or more synchronization reference signals associated with the second type of synchronization reference signal wherein at least one synchronization reference signal associated with the second type of synchronization reference signal fully overlaps in time and frequency with at least one synchronization reference signal associated with the first type of synchronization reference signal, and performing a procedure, with the UE, according to the at least one synchronization reference signal associated with the first type of synchronization reference signal, or according to the at least one synchronization reference signal associated with the second type of synchronization reference signal.

In a twenty-seventh aspect, alone or in combination with one or more of the first through twenty-sixth aspects, process 1100 includes transmitting a first transmit power indication associated with the first type of synchronization reference signal and transmitting a second transmit power indication, associated with the second type of synchronization reference signal, that is the same as the first transmit power indication.

In a twenty-eighth aspect, alone or in combination with one or more of the first through twenty-seventh aspects, process 1100 includes transmitting a first burst position indication associated with the first type of synchronization reference signal and transmitting a second burst position indication, associated with the second type of synchronization reference signal, that is the same as the first burst position indication.

In a twenty-ninth aspect, alone or in combination with one or more of the first through twenty-eighth aspects, process 1100 includes receiving a capability message that indicates UE support for communicating a first transmit power indication associated with the first type of synchronization reference signal and for communicating a second transmit power indication, associated with the second type of synchronization reference signal, that is different from the first transmit power indication.

In a thirtieth aspect, alone or in combination with one or more of the first through twenty-ninth aspects, process 1100 includes receiving a capability message that indicates UE support for communicating a first burst position indication associated with the first type of synchronization reference signal and for communicating a second burst position indication, associated with the second type of synchronization reference signal, that is different from the first burst position indication.

In a thirty-first aspect, alone or in combination with one or more of the first through thirtieth aspects, the second type of synchronization reference signal is deactivated after a threshold duration of time.

In a thirty-second aspect, alone or in combination with one or more of the first through thirty-first aspects, the second type of synchronization reference signal is deactivated in association with a deactivation of the secondary serving cell.

In a thirty-third aspect, alone or in combination with one or more of the first through thirty-second aspects, the process 1100 includes transmitting a quantity of synchronization reference signal bursts, wherein the second type of synchronization reference signal is deactivated in accordance with the quantity of synchronization reference signal bursts satisfying a threshold.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a network node or an apparatus of a network node, in accordance with the present disclosure. Example process 1200 is an example where the apparatus or the network node (e.g., network node 110) performs operations associated with radio frequency channel numbers for communicating on-demand SSBs using carrier aggregation.

As shown in FIG. 12, in some aspects, process 1200 may include transmitting at least one of a first frequency channel number for communication of a first type of synchronization reference signal between a UE and a secondary serving cell or a second frequency channel number for communication of a second type of synchronization reference signal between the UE and the secondary serving cell (block 1210). For example, the network node (e.g., using transmission component 1404 and/or communication manager 1406, depicted in FIG. 14) may transmit at least one of a first frequency channel number for communication of a first type of synchronization reference signal between a UE and a secondary serving cell or a second frequency channel number for communication of a second type of synchronization reference signal between the UE and the secondary serving cell, as described above.

Process 1200 may include additional aspects, such as any single aspect or any combination of aspects described below and/or in connection with one or more other processes described elsewhere herein.

In a first aspect, the second frequency channel number is a same frequency channel number as the first frequency channel number.

In a second aspect, alone or in combination with the first aspect, the second frequency channel number is a different frequency channel number than the first frequency channel number.

In a third aspect, alone or in combination with one or more of the first and second aspects, the serving cell includes at least one of a primary serving cell, or an additional secondary serving cell.

In a fourth aspect, alone or in combination with one or more of the first through third aspects, the secondary serving cell is configured for communicating synchronization reference signals associated with the second type of synchronization reference signal, and an active bandwidth part associated with the secondary serving cell includes a set of one or more frequency resources, according to the second frequency channel number, for communicating the second type of synchronization reference signal.

In a fifth aspect, alone or in combination with one or more of the first through fourth aspects, an active bandwidth part associated with the secondary serving cell includes a first set of one or more frequency resources for communicating the first type of synchronization reference signal according to the first frequency channel number and includes a second set of one or more frequency resources for communicating the second type of synchronization reference signal according to the second frequency channel number.

In a sixth aspect, alone or in combination with one or more of the first through fifth aspects, the secondary serving cell is configured for communicating synchronization reference signals associated with the second type of synchronization reference signal and is precluded from communicating synchronization reference signals associated with the first type of synchronization reference signal.

In a seventh aspect, alone or in combination with one or more of the first through sixth aspects, the secondary serving cell is configured to communicate synchronization reference signals associated with the first type of synchronization reference signal and to communicate synchronization reference signals associated with the second type of synchronization reference signal, and the second frequency channel number is a same frequency channel number as the first frequency channel number.

In an eighth aspect, alone or in combination with one or more of the first through seventh aspects, process 1200 includes transmitting a configuration message, associated with the secondary serving cell, including at least one of a first configuration for communicating the first type of synchronization reference signal or a second configuration for communicating the second type of synchronization reference signal.

In a ninth aspect, alone or in combination with one or more of the first through eighth aspects, the first configuration includes the first frequency channel number, and the second configuration includes the second frequency channel number.

In a tenth aspect, alone or in combination with one or more of the first through ninth aspects, the configuration message indicates a capability of the secondary serving cell for communicating the first type of synchronization reference signal and a capability of the secondary serving cell for communicating the second type of synchronization reference signal.

In an eleventh aspect, alone or in combination with one or more of the first through tenth aspects, transmitting the configuration message comprises transmitting at least one of a radio resource control message, a medium access control message, or a downlink control message.

In a twelfth aspect, alone or in combination with one or more of the first through eleventh aspects, process 1200 includes receiving a UE capability message indicating that the UE is capable of communicating synchronization reference signals according to the first frequency channel number and indicating that the UE is capable of communicating synchronization reference signals according to the second frequency channel number, wherein the first frequency channel number is different than the second frequency channel number.

In a thirteenth aspect, alone or in combination with one or more of the first through twelfth aspects, the UE capability message indicates at least one of a respective capability for each frequency band associated with communications at the UE, a respective capability for each frequency band combination associated with communications at the UE, a respective capability for each component carrier associated with communications at the UE, a respective capability for each combination of frequency band and frequency band combination associated with communications at the UE, or a respective capability for each combination of frequency band, frequency band combination, and component carrier associated with communications at the UE.

In a fourteenth aspect, alone or in combination with one or more of the first through thirteenth aspects, process 1200 includes transmitting an indication of a periodicity associated with transmitting the one or more synchronization reference signals according to the second frequency channel number, wherein the first frequency channel number is a same frequency channel number as the second frequency channel number.

In a fifteenth aspect, alone or in combination with one or more of the first through fourteenth aspects, the indication of the periodicity includes a plurality of periodicities, the method further comprising transmitting a control message indicating the periodicity of the plurality of periodicities.

In a sixteenth aspect, alone or in combination with one or more of the first through fifteenth aspects, process 1200 includes transmitting an indication of one or more transmission powers associated with the second type of synchronization reference signal.

In a seventeenth aspect, alone or in combination with one or more of the first through sixteenth aspects, process 1200 includes transmitting a control message indicating a transmission power, of the one or more transmission powers, associated with communication of one or more synchronization reference signals associated with the second type of synchronization reference signal.

In an eighteenth aspect, alone or in combination with one or more of the first through seventeenth aspects, process 1200 includes transmitting an indication of one or more transmission powers associated with the first type of synchronization reference signal and the second type of synchronization reference signal.

In a nineteenth aspect, alone or in combination with one or more of the first through eighteenth aspects, process 1200 includes transmitting an indication of a set of time-frequency resources associated with a set of synchronization reference signals to be communicated by the secondary serving cell, wherein the one or more synchronization reference signals include the set of synchronization reference signals.

In a twentieth aspect, alone or in combination with one or more of the first through nineteenth aspects, process 1200 includes transmitting a first transmit power indication associated with the first type of synchronization reference signal and transmitting a second transmit power indication, associated with the second type of synchronization reference signal, that is the same as the first transmit power indication.

In a twenty-first aspect, alone or in combination with one or more of the first through twenty-seventh aspects, process 1200 includes transmitting a first burst position indication associated with the first type of synchronization reference signal and transmitting a second burst position indication, associated with the second type of synchronization reference signal, that is the same as the first burst position indication.

In a twenty-third aspect, alone or in combination with one or more of the first through twenty-second aspects, process 1200 includes receiving a capability message that indicates UE support for communicating a first transmit power indication associated with the first type of synchronization reference signal and for communicating a second transmit power indication, associated with the second type of synchronization reference signal, that is different from the first transmit power indication.

In a twenty-fourth aspect, alone or in combination with one or more of the first through twenty-third aspects, process 1200 includes receiving a capability message that indicates UE support for communicating a first burst position indication associated with the first type of synchronization reference signal and for communicating a second burst position indication, associated with the second type of synchronization reference signal, that is different from the first burst position indication.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 140 described in connection with FIG. 1) of the UE.

In some aspects, the apparatus 1300 may be configured to perform one or more operations described herein in connection with FIGS. 7-9. Additionally, or alternatively, the apparatus 1300 may be configured to perform one or more processes described herein, such as process 1000 of FIG. 10, or a combination thereof. In some aspects, the apparatus 1300 and/or one or more components shown in FIG. 13 may include one or more components of the UE described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the UE described above in connection with FIG. 1, such as a radio, one or more RF chains, one or more transceivers, or one or more modems, each of which may in turn be coupled with one or more antennas of the UE.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1304 may be co-located with the reception component 1302.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive, via a serving cell, at least one of a first frequency channel number for communicating a first type of synchronization reference signal with a secondary serving cell or a second frequency channel number for communicating a second type of synchronization reference signal with the secondary serving cell. The reception component 1302 may receive one or more synchronization reference signals associated with at least one of the first type of synchronization reference signal or the second type of synchronization reference signal according to at least one of the first frequency channel number or the second frequency channel number.

The communication manager 1306 may perform a procedure associated with the second type of synchronization reference signal in association with receiving one or more synchronization reference signals associated with the second type of synchronization reference signal.

The reception component 1302 may receive, via the first set of one or more frequency resources from the secondary serving cell, one or more synchronization reference signals associated with the first type of synchronization reference signal.

The reception component 1302 may receive, via the second set of one or more frequency resources from the secondary serving cell, one or more synchronization reference signals associated with the second type of synchronization reference signal.

The communication manager 1306 may perform a procedure, with the secondary serving cell, using the one or more synchronization reference signals associated with the first type of synchronization reference signal, the one or more synchronization reference signals associated with the second type of synchronization reference signal, or both.

The reception component 1302 may receive one or more synchronization reference signals associated with the second type of synchronization reference signal according to the first frequency channel number.

The communication manager 1306 may refrain from monitoring a frequency channel associated with the first frequency channel number.

The reception component 1302 may receive a configuration message, associated with the secondary serving cell, including at least one of a first configuration for communicating the first type of synchronization reference signal or a second configuration for communicating the second type of synchronization reference signal, wherein receiving the one or more synchronization reference signals associated with at least one of the first type of synchronization reference signal or the second type of synchronization reference signal is in accordance with the configuration message.

The transmission component 1304 may transmit a UE capability message indicating that the UE is capable of receiving synchronization reference signals according to the first frequency channel number and indicating that the UE is capable of receiving synchronization reference signals according to the second frequency channel number, wherein the first frequency channel number is different than the second frequency channel number.

The reception component 1302 may receive an indication of a periodicity associated with receiving the one or more synchronization reference signals according to the second frequency channel number, wherein the first frequency channel number is a same frequency channel number as the second frequency channel number.

The reception component 1302 may receive, according to the second frequency channel number and from the secondary serving cell, one or more synchronization reference signals associated with the first type of synchronization reference signal and one or more synchronization reference signals associated with the second type of synchronization reference signal according to the periodicity.

The reception component 1302 may receive an indication of one or more transmission powers associated with the second type of synchronization reference signal.

The reception component 1302 may receive a control message indicating a transmission power, of the one or more transmission powers, associated with receiving one or more synchronization reference signals associated with the second type of synchronization reference signal.

The reception component 1302 may receive an indication of one or more transmission powers associated with the first type of synchronization reference signal and the second type of synchronization reference signal.

The reception component 1302 may receive an indication of a set of time-frequency resources associated with a set of synchronization reference signals to be communicated with the secondary serving cell, wherein the one or more synchronization reference signals include the set of synchronization reference signals.

The reception component 1302 may receive, according to the first frequency channel number, one or more synchronization reference signals associated with the first type of synchronization reference signal.

The reception component 1302 may receive, according to the second frequency channel number, one or more synchronization reference signals associated with the second type of synchronization reference signal, wherein at least one synchronization reference signal associated with the second type of synchronization reference signal at least partially overlaps in time and frequency with at least one synchronization reference signal associated with the first type of synchronization reference signal.

The communication manager 1306 may identify an error associated with receiving at least one of the one or more synchronization reference signals associated with the first type of synchronization reference signal or the one or more synchronization reference signals associated with the second type of synchronization reference signal.

The reception component 1302 may receive, according to the first frequency channel number, one or more synchronization reference signals associated with the first type of synchronization reference signal.

The reception component 1302 may receive, according to the second frequency channel number, one or more synchronization reference signals associated with the second type of synchronization reference signal, wherein at least one synchronization reference signal associated with the second type of synchronization reference signal fully overlaps in time and frequency with at least one synchronization reference signal associated with the first type of synchronization reference signal.

The communication manager 1306 may perform a procedure, with the secondary serving cell, using the at least one synchronization reference signal associated with the first type of synchronization reference signal, or using the at least one synchronization reference signal associated with the second type of synchronization reference signal.

The reception component 1302 may receive a first transmit power indication associated with the first type of synchronization reference signal, and receive a second transmit power indication, associated with the second type of synchronization reference signal, that is the same as the first transmit power indication.

The reception component 1302 may receive a first burst position indication associated with the first type of synchronization reference signal and may receive a second burst position indication, associated with the second type of synchronization reference signal, that is the same as the first burst position indication.

The transmission component 1304 may transmit a capability message that indicates UE support for receiving a first transmit power indication associated with the first type of synchronization reference signal and for receiving a second transmit power indication, associated with the second type of synchronization reference signal, that is different from the first transmit power indication.

The transmission component 1304 may transmit a capability message that indicates UE support for receiving a first burst position indication associated with the first type of synchronization reference signal and for receiving a second burst position indication, associated with the second type of synchronization reference signal, that is different from the first burst position indication.

The reception component 1302 may receive a quantity of synchronization reference signal bursts, wherein the second type of synchronization reference signal is deactivated in accordance with the quantity of synchronization reference signal bursts satisfying a threshold.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 155 described in connection with FIG. 1. As shown, the apparatus 1400 may communicate with another apparatus 1408, such as a UE or a network node (such as a CU, a DU, an RU, or a base station), using the reception component 1402 and the transmission component 1404. The communication manager 1406 may be included in, or implemented via, a processing system (for example, the processing system 145 described in connection with FIG. 1) of the network node.

In some aspects, the apparatus 1400 may be configured to perform one or more operations described herein in connection with FIGS. 7-9. Additionally, or alternatively, the apparatus 1400 may be configured to perform one or more processes described herein, such as process 1100 of FIG. 11, process 1200 of FIG. 12, or a combination thereof. In some aspects, the apparatus 1400 and/or one or more components shown in FIG. 14 may include one or more components of the network node described in connection with FIG. 1. Additionally, or alternatively, one or more components shown in FIG. 14 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components of the network node described above in connection with FIG. 1, such as a radio, one or more RF chains, one or more transceivers, or one or more modems, each of which may in turn be coupled with one or more antennas of the network node. In some aspects, the reception component 1402 and/or the transmission component 1404 may include or may be included in a network interface. The network interface may be configured to obtain and/or output signals for the apparatus 1400 via one or more communications links, such as a backhaul link, a midhaul link, and/or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications, and may transmit the processed signals to the apparatus 1408. In some aspects, the transmission component 1404 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1404 may be co-located with the reception component 1402.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The transmission component 1404 may transmit, to a UE, one or more synchronization reference signals associated with at least one of a first type of synchronization reference signal or a second type of synchronization reference signal according to at least one of a first frequency channel number for communicating the first type of synchronization reference signal or a second frequency channel number for communicating the second type of synchronization reference signal.

The communication manager 1406 may perform a procedure associated with the second type of synchronization reference signal in association with transmitting one or more synchronization reference signals associated with the second type of synchronization reference signal.

The transmission component 1404 may transmit, via the first set of one or more frequency resources, one or more synchronization reference signals associated with the first type of synchronization reference signal.

The transmission component 1404 may transmit, via the second set of one or more frequency resources, one or more synchronization reference signals associated with the second type of synchronization reference signal.

The communication manager 1406 may perform a procedure, with the UE using the one or more synchronization reference signals associated with the first type of synchronization reference signal, the one or more synchronization reference signals associated with the second type of synchronization reference signal, or both.

The transmission component 1404 may transmit a configuration message, associated with the secondary serving cell, including at least one of a first configuration for communicating the first type of synchronization reference signal or a second configuration for communicating the second type of synchronization reference signal, wherein transmitting the one or more synchronization reference signals associated with at least one of the first type of synchronization reference signal or the second type of synchronization reference signal is in accordance with the configuration message.

The reception component 1402 may receive a UE capability message indicating that the UE is capable of communicating synchronization reference signals according to the first frequency channel number and indicating that the UE is capable of communicating synchronization reference signals according to the second frequency channel number, wherein the first frequency channel number is different than the second frequency channel number.

The transmission component 1404 may transmit an indication of a periodicity associated with transmitting the one or more synchronization reference signals according to the second frequency channel number, wherein the first frequency channel number is a same frequency channel number as the second frequency channel number.

The transmission component 1404 may transmit, according to the second frequency channel number, one or more synchronization reference signals associated with the first type of synchronization reference signal and one or more synchronization reference signals associated with the second type of synchronization reference signal according to the periodicity.

The transmission component 1404 may transmit an indication of one or more transmission powers associated with the second type of synchronization reference signal.

The transmission component 1404 may transmit a control message indicating a transmission power, of the one or more transmission powers, associated with transmitting one or more synchronization reference signals associated with the second type of synchronization reference signal.

The transmission component 1404 may transmit an indication of one or more transmission powers associated with the first type of synchronization reference signal and the second type of synchronization reference signal.

The transmission component 1404 may transmit an indication of a set of time-frequency resources associated with a set of synchronization reference signals to be communicated with the secondary serving cell, wherein the one or more synchronization reference signals include the set of synchronization reference signals.

The transmission component 1404 may transmit, according to the first frequency channel number, one or more synchronization reference signals associated with the first type of synchronization reference signal.

The communication manager 1406 may refrain from transmitting, according to the second frequency channel number, at least one synchronization reference signal associated with the second type of synchronization reference signal that at least partially overlaps in time and frequency with at least one synchronization reference signal associated with the first type of synchronization reference signal.

The transmission component 1404 may transmit, according to the first frequency channel number, one or more synchronization reference signals associated with the first type of synchronization reference signal.

The transmission component 1404 may transmit, according to the second frequency channel number, one or more synchronization reference signals associated with the second type of synchronization reference signal, wherein at least one synchronization reference signal associated with the second type of synchronization reference signal fully overlaps in time and frequency with at least one synchronization reference signal associated with the first type of synchronization reference signal.

The communication manager 1406 may perform a procedure, with the UE, according to the at least one synchronization reference signal associated with the first type of synchronization reference signal, or according to the at least one synchronization reference signal associated with the second type of synchronization reference signal.

The transmission component 1404 may transmit a first transmit power indication associated with the first type of synchronization reference signal, and transmit a second transmit power indication, associated with the second type of synchronization reference signal, that is the same as the first transmit power indication.

The transmission component 1404 may transmit a first burst position indication associated with the first type of synchronization reference signal and may transmit a second burst position indication, associated with the second type of synchronization reference signal, that is the same as the first burst position indication.

The reception component 1402 may transmit a capability message that indicates UE support for communicating a first transmit power indication associated with the first type of synchronization reference signal and for receiving a second transmit power indication, associated with the second type of synchronization reference signal, that is different from the first transmit power indication.

The reception component 1402 may receive a capability message that indicates UE support for communicating a first burst position indication associated with the first type of synchronization reference signal and for receiving a second burst position indication, associated with the second type of synchronization reference signal, that is different from the first burst position indication.

The transmission component 1404 may transmit a quantity of synchronization reference signal bursts, wherein the second type of synchronization reference signal is deactivated in accordance with the quantity of synchronization reference signal bursts satisfying a threshold.

The transmission component 1404 may transmit at least one of a first frequency channel number for communication of a first type of synchronization reference signal between a UE and a secondary serving cell or a second frequency channel number for communication of a second type of synchronization reference signal between the UE and the secondary serving cell.

The transmission component 1404 may transmit a configuration message, associated with the secondary serving cell, including at least one of a first configuration for communicating the first type of synchronization reference signal or a second configuration for communicating the second type of synchronization reference signal.

The reception component 1402 may receive a UE capability message indicating that the UE is capable of communicating synchronization reference signals according to the first frequency channel number and indicating that the UE is capable of communicating synchronization reference signals according to the second frequency channel number, wherein the first frequency channel number is different than the second frequency channel number.

The transmission component 1404 may transmit an indication of a periodicity associated with transmitting the one or more synchronization reference signals according to the second frequency channel number, wherein the first frequency channel number is a same frequency channel number as the second frequency channel number.

The transmission component 1404 may transmit an indication of one or more transmission powers associated with the second type of synchronization reference signal.

The transmission component 1404 may transmit a control message indicating a transmission power, of the one or more transmission powers, associated with communication of one or more synchronization reference signals associated with the second type of synchronization reference signal.

The transmission component 1404 may transmit an indication of one or more transmission powers associated with the first type of synchronization reference signal and the second type of synchronization reference signal.

The transmission component 1404 may transmit an indication of a set of time-frequency resources associated with a set of synchronization reference signals to be communicated by the secondary serving cell, wherein the one or more synchronization reference signals include the set of synchronization reference signals.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: receiving, via a serving cell, at least one of a first frequency channel number for communicating a first type of synchronization reference signal with a secondary serving cell or a second frequency channel number for communicating a second type of synchronization reference signal with the secondary serving cell; and receiving one or more synchronization reference signals associated with at least one of the first type of synchronization reference signal or the second type of synchronization reference signal according to at least one of the first frequency channel number or the second frequency channel number.

Aspect 2: The method of Aspect 1, wherein the second frequency channel number is a same frequency channel number as the first frequency channel number.

Aspect 3: The method of Aspect 1, wherein the second frequency channel number is a different frequency channel number than the first frequency channel number.

Aspect 4: The method of any of Aspects 1-3, wherein the serving cell includes at least one of a primary serving cell, or an additional secondary serving cell.

Aspect 5: The method of any of Aspects 1-4, wherein: the secondary serving cell is configured for communicating synchronization reference signals associated with the second type of synchronization reference signal; and an active bandwidth part associated with the secondary serving cell includes a set of one or more frequency resources, according to the second frequency channel number, for communicating the second type of synchronization reference signal.

Aspect 6: The method of Aspect 5, further comprising: performing a procedure associated with the second type of synchronization reference signal in association with receiving one or more synchronization reference signals associated with the second type of synchronization reference signal.

Aspect 7: The method of any of Aspects 1-6, wherein an active bandwidth part associated with the secondary serving cell includes a first set of one or more frequency resources for communicating the first type of synchronization reference signal according to the first frequency channel number and includes a second set of one or more frequency resources for communicating the second type of synchronization reference signal according to the second frequency channel number.

Aspect 8: The method of Aspect 7, further comprising: receiving, via the first set of one or more frequency resources from the secondary serving cell, one or more synchronization reference signals associated with the first type of synchronization reference signal; receiving, via the second set of one or more frequency resources from the secondary serving cell, one or more synchronization reference signals associated with the second type of synchronization reference signal; and performing a procedure, with the secondary serving cell, using the one or more synchronization reference signals associated with the first type of synchronization reference signal, the one or more synchronization reference signals associated with the second type of synchronization reference signal, or both.

Aspect 9: The method of any of Aspects 1-8, wherein the secondary serving cell is configured for communicating synchronization reference signals associated with the second type of synchronization reference signal and is precluded from communicating synchronization reference signals associated with the first type of synchronization reference signal, and wherein receiving the one or more synchronization reference signals comprises: receiving one or more synchronization reference signals associated with the second type of synchronization reference signal according to the first frequency channel number.

Aspect 10: The method of any of Aspects 1-9, wherein: the secondary serving cell is configured to communicate synchronization reference signals associated with the first type of synchronization reference signal and to communicate synchronization reference signals associated with the second type of synchronization reference signal, and the second frequency channel number is a same frequency channel number as the first frequency channel number.

Aspect 11: The method of any of Aspects 1-10, further comprising: receiving a configuration message, associated with the secondary serving cell, including at least one of a first configuration for communicating the first type of synchronization reference signal or a second configuration for communicating the second type of synchronization reference signal, wherein receiving the one or more synchronization reference signals associated with at least one of the first type of synchronization reference signal or the second type of synchronization reference signal is in accordance with the configuration message.

Aspect 12: The method of Aspect 11, wherein the first configuration includes the first frequency channel number, and the second configuration includes the second frequency channel number.

Aspect 13: The method of any of Aspects 11-12, wherein the configuration message indicates a capability of the secondary serving cell for communicating the first type of synchronization reference signal and a capability of the secondary serving cell for communicating the second type of synchronization reference signal.

Aspect 14: The method of any of Aspects 11-13, wherein receiving the configuration message comprises: receiving at least one of a radio resource control message, a medium access control message, or a downlink control message.

Aspect 15: The method of any of Aspects 1-14, further comprising: transmitting a UE capability message indicating that the UE is capable of receiving synchronization reference signals according to the first frequency channel number and indicating that the UE is capable of receiving synchronization reference signals according to the second frequency channel number, wherein the first frequency channel number is different than the second frequency channel number.

Aspect 16: The method of Aspect 15, wherein the UE capability message indicates at least one of: a respective capability for each frequency band associated with communications at the UE, a respective capability for each frequency band combination associated with communications at the UE, a respective capability for each component carrier associated with communications at the UE, a respective capability for each combination of frequency band and frequency band combination associated with communications at the UE, or a respective capability for each combination of frequency band, frequency band combination, and component carrier associated with communications at the UE.

Aspect 17: The method of any of Aspects 1-16, further comprising: receiving an indication of a periodicity associated with receiving the one or more synchronization reference signals according to the second frequency channel number, wherein the first frequency channel number is a same frequency channel number as the second frequency channel number.

Aspect 18: The method of Aspect 17, further comprising: receiving, according to the second frequency channel number and from the secondary serving cell, one or more synchronization reference signals associated with the first type of synchronization reference signal and one or more synchronization reference signals associated with the second type of synchronization reference signal according to the periodicity.

Aspect 19: The method of any of Aspects 17-18, wherein the indication of the periodicity includes a plurality of periodicities, the method further comprising: receiving a control message indicating the periodicity of the plurality of periodicities.

Aspect 20: The method of any of Aspects 1-19, further comprising: receiving an indication of one or more transmission powers associated with the second type of synchronization reference signal.

Aspect 21: The method of Aspect 20, further comprising: receiving a control message indicating a transmission power, of the one or more transmission powers, associated with receiving one or more synchronization reference signals associated with the second type of synchronization reference signal.

Aspect 22: The method of any of Aspects 1-21, further comprising: receiving an indication of one or more transmission powers associated with the first type of synchronization reference signal and the second type of synchronization reference signal.

Aspect 23: The method of any of Aspects 1-22, further comprising: receiving an indication of a set of time-frequency resources associated with a set of synchronization reference signals to be communicated with the secondary serving cell, wherein the one or more synchronization reference signals include the set of synchronization reference signals.

Aspect 24: The method of any of Aspects 1-23, wherein receiving the one or more synchronization reference signals comprises: receiving, via a first set of time resources, one or more synchronization reference signals associated with the first type of synchronization reference signal; and receiving, via a second set of time resources, one or more synchronization reference signals associated with the second type of synchronization reference signal, wherein each resource of the second set of time resources is offset from a resource of the first set of time resources by a time offset.

Aspect 25: The method of Aspect 24, wherein the time offset is associated with at least one of the first set of time resources, the secondary serving cell, or a time resource identifier of a first occurring time resource associated with the secondary serving cell.

Aspect 26: The method of any of Aspects 1-25, further comprising: receiving, according to the first frequency channel number, one or more synchronization reference signals associated with the first type of synchronization reference signal; receiving, according to the second frequency channel number, one or more synchronization reference signals associated with the second type of synchronization reference signal, wherein at least one synchronization reference signal associated with the second type of synchronization reference signal at least partially overlaps in time and frequency with at least one synchronization reference signal associated with the first type of synchronization reference signal; and identifying an error associated with receiving at least one of the one or more synchronization reference signals associated with the first type of synchronization reference signal or the one or more synchronization reference signals associated with the second type of synchronization reference signal.

Aspect 27: The method of any of Aspects 1-26, further comprising: receiving, according to the first frequency channel number, one or more synchronization reference signals associated with the first type of synchronization reference signal; receiving, according to the second frequency channel number, one or more synchronization reference signals associated with the second type of synchronization reference signal wherein at least one synchronization reference signal associated with the second type of synchronization reference signal fully overlaps in time and frequency with at least one synchronization reference signal associated with the first type of synchronization reference signal; and performing a procedure, with the secondary serving cell, using the at least one synchronization reference signal associated with the first type of synchronization reference signal, or using the at least one synchronization reference signal associated with the second type of synchronization reference signal.

Aspect 28: A method of wireless communication performed by a network node associated with a secondary serving cell, comprising: transmitting, to a UE, one or more synchronization reference signals associated with at least one of a first type of synchronization reference signal or a second type of synchronization reference signal according to at least one of a first frequency channel number for communicating the first type of synchronization reference signal or a second frequency channel number for communicating the second type of synchronization reference signal.

Aspect 29: The method of Aspect 28, wherein the second frequency channel number is a same frequency channel number as the first frequency channel number.

Aspect 30: The method of Aspect 28, wherein the second frequency channel number is a different frequency channel number than the first frequency channel number.

Aspect 31: The method of any of Aspects 28-30, wherein: the secondary serving cell is configured for communicating synchronization reference signals associated with the second type of synchronization reference signal; and an active bandwidth part associated with the secondary serving cell includes a set of one or more frequency resources, according to the second frequency channel number, for communicating the second type of synchronization reference signal.

Aspect 32: The method of Aspect 31, further comprising: performing a procedure associated with the second type of synchronization reference signal in association with transmitting one or more synchronization reference signals associated with the second type of synchronization reference signal.

Aspect 33: The method of any of Aspects 28-32, wherein an active bandwidth part associated with the secondary serving cell includes a first set of one or more frequency resources for communicating the first type of synchronization reference signal according to the first frequency channel number and includes a second set of one or more frequency resources for communicating the second type of synchronization reference signal according to the second frequency channel number.

Aspect 34: The method of Aspect 33, further comprising: transmitting, via the first set of one or more frequency resources, one or more synchronization reference signals associated with the first type of synchronization reference signal; transmitting, via the second set of one or more frequency resources, one or more synchronization reference signals associated with the second type of synchronization reference signal; and performing a procedure, with a user equipment (UE) using the one or more synchronization reference signals associated with the first type of synchronization reference signal, the one or more synchronization reference signals associated with the second type of synchronization reference signal, or both.

Aspect 35: The method of any of Aspects 28-34, wherein the secondary serving cell is configured for communicating synchronization reference signals associated with the second type of synchronization reference signal and is precluded from communicating synchronization reference signals associated with the first type of synchronization reference signal, and wherein transmitting the one or more synchronization reference signals comprises: transmitting one or more synchronization reference signals associated with the second type of synchronization reference signal according to the first frequency channel number.

Aspect 36: The method of any of Aspects 28-35, wherein: the secondary serving cell is configured to communicate synchronization reference signals associated with the first type of synchronization reference signal and to communicate synchronization reference signals associated with the second type of synchronization reference signal, and the second frequency channel number is a same frequency channel number as the first frequency channel number.

Aspect 37: The method of any of Aspects 28-36, further comprising: transmitting a configuration message, associated with the secondary serving cell, including at least one of a first configuration for communicating the first type of synchronization reference signal or a second configuration for communicating the second type of synchronization reference signal, wherein transmitting the one or more synchronization reference signals associated with at least one of the first type of synchronization reference signal or the second type of synchronization reference signal is in accordance with the configuration message.

Aspect 38: The method of Aspect 37, wherein the first configuration includes the first frequency channel number, and the second configuration includes the second frequency channel number.

Aspect 39: The method of any of Aspects 37-38, wherein the configuration message indicates a capability of the secondary serving cell for communicating the first type of synchronization reference signal and a capability of the secondary serving cell for communicating the second type of synchronization reference signal.

Aspect 40: The method of any of Aspects 37-38, wherein transmitting the configuration message comprises: transmitting at least one of a radio resource control message, a medium access control message, or a downlink control message.

Aspect 41: The method of any of Aspects 28-40, further comprising: receiving a UE capability message indicating that the UE is capable of communicating synchronization reference signals according to the first frequency channel number and indicating that the UE is capable of communicating synchronization reference signals according to the second frequency channel number, wherein the first frequency channel number is different than the second frequency channel number.

Aspect 42: The method of Aspect 41, wherein the UE capability message indicates at least one of: a respective capability for each frequency band associated with communications at the UE, a respective capability for each frequency band combination associated with communications at the UE, a respective capability for each component carrier associated with communications at the UE, a respective capability for each combination of frequency band and frequency band combination associated with communications at the UE, or a respective capability for each combination of frequency band, frequency band combination, and component carrier associated with communications at the UE.

Aspect 43: The method of any of Aspects 28-42, further comprising: transmitting an indication of a periodicity associated with transmitting the one or more synchronization reference signals according to the second frequency channel number, wherein the first frequency channel number is a same frequency channel number as the second frequency channel number.

Aspect 44: The method of Aspect 43, further comprising: transmitting, according to the second frequency channel number, one or more synchronization reference signals associated with the first type of synchronization reference signal and one or more synchronization reference signals associated with the second type of synchronization reference signal according to the periodicity.

Aspect 45: The method of Aspect 43, wherein the indication of the periodicity includes a plurality of periodicities, the method further comprising: transmitting a control message indicating the periodicity of the plurality of periodicities.

Aspect 46: The method of any of Aspects 28-45, further comprising: transmitting an indication of one or more transmission powers associated with the second type of synchronization reference signal.

Aspect 47: The method of Aspect 46, further comprising: transmitting a control message indicating a transmission power, of the one or more transmission powers, associated with transmitting one or more synchronization reference signals associated with the second type of synchronization reference signal.

Aspect 48: The method of any of Aspects 28-47, further comprising: transmitting an indication of one or more transmission powers associated with the first type of synchronization reference signal and the second type of synchronization reference signal.

Aspect 49: The method of any of Aspects 28-48, further comprising: transmitting an indication of a set of time-frequency resources associated with a set of synchronization reference signals to be communicated with the secondary serving cell, wherein the one or more synchronization reference signals include the set of synchronization reference signals.

Aspect 50: The method of any of Aspects 28-49, wherein transmitting the one or more synchronization reference signals comprises: transmitting, via a first set of time resources, one or more synchronization reference signals associated with the first type of synchronization reference signal; and transmitting, via a second set of time resources, one or more synchronization reference signals associated with the second type of synchronization reference signal, wherein each resource of the second set of time resources is offset from a resource of the first set of time resources by a time offset.

Aspect 51: The method of Aspect 50, wherein the time offset is associated with at least one of the first set of time resources, the secondary serving cell, or a time resource identifier of a first occurring time resource associated with the secondary serving cell.

Aspect 52: The method of any of Aspects 28-51, further comprising: transmitting, according to the first frequency channel number, one or more synchronization reference signals associated with the first type of synchronization reference signal; refraining from transmitting, according to the second frequency channel number, at least one synchronization reference signal associated with the second type of synchronization reference signal that at least partially overlaps in time and frequency with at least one synchronization reference signal associated with the first type of synchronization reference signal.

Aspect 53: The method of any of Aspects 28-52, further comprising: transmitting, according to the first frequency channel number, one or more synchronization reference signals associated with the first type of synchronization reference signal; transmitting, according to the second frequency channel number, one or more synchronization reference signals associated with the second type of synchronization reference signal wherein at least one synchronization reference signal associated with the second type of synchronization reference signal fully overlaps in time and frequency with at least one synchronization reference signal associated with the first type of synchronization reference signal; and performing a procedure, with a user equipment (UE), according to the at least one synchronization reference signal associated with the first type of synchronization reference signal, or according to the at least one synchronization reference signal associated with the second type of synchronization reference signal.

Aspect 54: A method of wireless communication performed by a network node associated with a serving cell, comprising: transmitting at least one of a first frequency channel number for communication of a first type of synchronization reference signal between a user equipment (UE) and a secondary serving cell or a second frequency channel number for communication of a second type of synchronization reference signal between the UE and the secondary serving cell.

Aspect 55: The method of Aspect 54, wherein the second frequency channel number is a same frequency channel number as the first frequency channel number.

Aspect 56: The method of Aspect 54, wherein the second frequency channel number is a different frequency channel number than the first frequency channel number.

Aspect 57: The method of any of Aspects 54-56, wherein the serving cell includes at least one of a primary serving cell, or an additional secondary serving cell.

Aspect 58: The method of any of Aspects 54-57, wherein: the secondary serving cell is configured for communicating synchronization reference signals associated with the second type of synchronization reference signal; and an active bandwidth part associated with the secondary serving cell includes a set of one or more frequency resources, according to the second frequency channel number, for communicating the second type of synchronization reference signal.

Aspect 59: The method of any of Aspects 54-58, wherein an active bandwidth part associated with the secondary serving cell includes a first set of one or more frequency resources for communicating the first type of synchronization reference signal according to the first frequency channel number and includes a second set of one or more frequency resources for communicating the second type of synchronization reference signal according to the second frequency channel number.

Aspect 60: The method of any of Aspects 54-59, wherein the secondary serving cell is configured for communicating synchronization reference signals associated with the second type of synchronization reference signal and is precluded from communicating synchronization reference signals associated with the first type of synchronization reference signal.

Aspect 61: The method of any of Aspects 54-60, wherein: the secondary serving cell is configured to communicate synchronization reference signals associated with the first type of synchronization reference signal and to communicate synchronization reference signals associated with the second type of synchronization reference signal, and the second frequency channel number is a same frequency channel number as the first frequency channel number.

Aspect 62: The method of any of Aspects 54-61, further comprising: transmitting a configuration message, associated with the secondary serving cell, including at least one of a first configuration for communicating the first type of synchronization reference signal or a second configuration for communicating the second type of synchronization reference signal.

Aspect 63: The method of Aspect 62, wherein the first configuration includes the first frequency channel number, and the second configuration includes the second frequency channel number.

Aspect 64: The method of any of Aspects 62-63, wherein the configuration message indicates a capability of the secondary serving cell for communicating the first type of synchronization reference signal and a capability of the secondary serving cell for communicating the second type of synchronization reference signal.

Aspect 65: The method of any of Aspects 62-64, wherein transmitting the configuration message comprises: transmitting at least one of a radio resource control message, a medium access control message, or a downlink control message.

Aspect 66: The method of any of Aspects 54-65, further comprising: receiving a UE capability message indicating that the UE is capable of communicating synchronization reference signals according to the first frequency channel number and indicating that the UE is capable of communicating synchronization reference signals according to the second frequency channel number, wherein the first frequency channel number is different than the second frequency channel number.

Aspect 67: The method of Aspect 66, wherein the UE capability message indicates at least one of: a respective capability for each frequency band associated with communications at the UE, a respective capability for each frequency band combination associated with communications at the UE, a respective capability for each component carrier associated with communications at the UE, a respective capability for each combination of frequency band and frequency band combination associated with communications at the UE, or a respective capability for each combination of frequency band, frequency band combination, and component carrier associated with communications at the UE.

Aspect 68: The method of any of Aspects 54-67, further comprising: transmitting an indication of a periodicity associated with transmitting the one or more synchronization reference signals according to the second frequency channel number, wherein the first frequency channel number is a same frequency channel number as the second frequency channel number.

Aspect 69: The method of Aspect 68, wherein the indication of the periodicity includes a plurality of periodicities, the method further comprising: transmitting a control message indicating the periodicity of the plurality of periodicities.

Aspect 70: The method of any of Aspects 54-69, further comprising: transmitting an indication of one or more transmission powers associated with the second type of synchronization reference signal.

Aspect 71: The method of Aspect 70, further comprising: transmitting a control message indicating a transmission power, of the one or more transmission powers, associated with communication of one or more synchronization reference signals associated with the second type of synchronization reference signal.

Aspect 72: The method of any of Aspects 54-71, further comprising: transmitting an indication of one or more transmission powers associated with the first type of synchronization reference signal and the second type of synchronization reference signal.

Aspect 73: The method of any of Aspects 54-72, further comprising: transmitting an indication of a set of time-frequency resources associated with a set of synchronization reference signals to be communicated by the secondary serving cell, wherein the one or more synchronization reference signals include the set of synchronization reference signals.

Aspect 74: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-73.

Aspect 75: An apparatus for wireless communication at a device, the apparatus comprising one or more memories and one or more processors coupled to the one or more memories, the one or more processors configured to cause the device to perform the method of one or more of Aspects 1-73.

Aspect 76: An apparatus for wireless communication, the apparatus comprising at least one means for performing the method of one or more of Aspects 1-73.

Aspect 77: A non-transitory computer-readable medium storing code for wireless communication, the code comprising instructions executable by one or more processors to perform the method of one or more of Aspects 1-73.

Aspect 78: A non-transitory computer-readable medium storing a set of instructions for wireless communication, the set of instructions comprising one or more instructions that, when executed by one or more processors of a device, cause the device to perform the method of one or more of Aspects 1-73.

Aspect 79: A device for wireless communication, the device comprising a processing system that includes one or more processors and one or more memories coupled with the one or more processors, the processing system configured to cause the device to perform the method of one or more of Aspects 1-73.

Aspect 80: An apparatus for wireless communication at a device, the apparatus comprising one or more memories and one or more processors coupled to the one or more memories, the one or more processors individually or collectively configured to cause the device to perform the method of one or more of Aspects 1-73.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive, via a serving cell, at least one of a first frequency channel number for communicating a first type of synchronization reference signal with a secondary serving cell or a second frequency channel number for communicating a second type of synchronization reference signal with the secondary serving cell; and
receive one or more synchronization reference signals associated with at least one of the first type of synchronization reference signal or the second type of synchronization reference signal according to at least one of the first frequency channel number or the second frequency channel number.

2. The apparatus of claim 1, wherein the one or more processors are further configured to cause the UE to:
receive a configuration message, associated with the secondary serving cell, including at least one of a first configuration for communicating the first type of synchronization reference signal or a second configuration for communicating the second type of synchronization reference signal, wherein receiving the one or more synchronization reference signals associated with at least one of the first type of synchronization reference signal or the second type of synchronization reference signal is in accordance with the configuration message.

3. The apparatus of claim 1, wherein the one or more processors are further configured to cause the UE to:
transmit a UE capability message indicating that the UE is capable of receiving synchronization reference signals according to the first frequency channel number and indicating that the UE is capable of receiving synchronization reference signals according to the second frequency channel number, wherein the first frequency channel number is different than the second frequency channel number.

4. The apparatus of claim 1, wherein the one or more processors are further configured to cause the UE to:
receive an indication of a periodicity associated with receiving the one or more synchronization reference signals according to the second frequency channel number, wherein the first frequency channel number is a same frequency channel number as the second frequency channel number.

5. The apparatus of claim 1, wherein the one or more processors are further configured to cause the UE to:
receive an indication of one or more transmission powers associated with the second type of synchronization reference signal.

6. The apparatus of claim 1, wherein the one or more processors are further configured to cause the UE to:
receive an indication of one or more transmission powers associated with the first type of synchronization reference signal and the second type of synchronization reference signal.

7. The apparatus of claim 1, wherein the one or more processors are further configured to cause the UE to:
receive an indication of a set of time-frequency resources associated with a set of synchronization reference signals to be communicated with the secondary serving cell, wherein the one or more synchronization reference signals include the set of synchronization reference signals.

8. A method of wireless communication performed by a user equipment (UE), comprising:
receiving, via a serving cell, at least one of a first frequency channel number for communicating a first type of synchronization reference signal with a secondary serving cell or a second frequency channel number for communicating a second type of synchronization reference signal with the secondary serving cell; and
receiving one or more synchronization reference signals associated with at least one of the first type of synchronization reference signal or the second type of synchronization reference signal according to at least one of the first frequency channel number or the second frequency channel number.

9. The method of claim 8, wherein:
the secondary serving cell is configured for communicating synchronization reference signals associated with the second type of synchronization reference signal; and
an active bandwidth part associated with the secondary serving cell includes a set of one or more frequency resources, according to the second frequency channel number, for communicating the second type of synchronization reference signal.

10. The method of claim 8, wherein an active bandwidth part associated with the secondary serving cell includes a first set of one or more frequency resources for communicating the first type of synchronization reference signal according to the first frequency channel number and includes a second set of one or more frequency resources for communicating the second type of synchronization reference signal according to the second frequency channel number.

11. The method of claim 8, wherein the secondary serving cell is configured for communicating synchronization reference signals associated with the second type of synchronization reference signal and is precluded from communicating synchronization reference signals associated with the first type of synchronization reference signal, and wherein receiving the one or more synchronization reference signals comprises:
receiving one or more synchronization reference signals associated with the second type of synchronization reference signal according to the first frequency channel number.

12. The method of claim 8, wherein the secondary serving cell is configured for communicating synchronization reference signals associated with the second type of synchronization reference signal and is precluded from communicating synchronization reference signals associated with the first type of synchronization reference signal, and wherein receiving the one or more synchronization reference signals comprises:
refraining from monitoring a frequency channel associated with the first frequency channel number.

13. The method of claim 8, wherein:
the secondary serving cell is configured to communicate synchronization reference signals associated with the first type of synchronization reference signal and to communicate synchronization reference signals associated with the second type of synchronization reference signal, and
the second frequency channel number is a same frequency channel number as the first frequency channel number.

14. A non-transitory computer-readable medium storing a set of instructions for wireless communication, the set of instructions comprising:
one or more instructions that, when executed by one or more processors of a user equipment (UE), cause the UE to:
receive, via a serving cell, at least one of a first frequency channel number for communicating a first type of synchronization reference signal with a secondary serving cell or a second frequency channel number for communicating a second type of synchronization reference signal with the secondary serving cell; and
receive one or more synchronization reference signals associated with at least one of the first type of synchronization reference signal or the second type of synchronization reference signal according to at least one of the first frequency channel number or the second frequency channel number.

15. The non-transitory computer-readable medium of claim 14, wherein the one or more instructions, that cause the UE to receive the one or more synchronization reference signals, cause the UE to:
receive, via a first set of time resources, one or more synchronization reference signals associated with the first type of synchronization reference signal; and
receive, via a second set of time resources, one or more synchronization reference signals associated with the second type of synchronization reference signal, wherein each resource of the second set of time resources is offset from a resource of the first set of time resources by a time offset.

16. The non-transitory computer-readable medium of claim 14, wherein the one or more instructions further cause the UE to:
receive, according to the first frequency channel number, one or more synchronization reference signals associated with the first type of synchronization reference signal;
receive, according to the second frequency channel number, one or more synchronization reference signals associated with the second type of synchronization reference signal, wherein at least one synchronization reference signal associated with the second type of synchronization reference signal at least partially overlaps in time and frequency with at least one synchronization reference signal associated with the first type of synchronization reference signal; and
identify an error associated with receiving at least one of the one or more synchronization reference signals associated with the first type of synchronization reference signal or the one or more synchronization reference signals associated with the second type of synchronization reference signal.

17. The non-transitory computer-readable medium of claim 14, wherein the one or more instructions further cause the UE to:
receive, according to the first frequency channel number, one or more synchronization reference signals associated with the first type of synchronization reference signal;
receive, according to the second frequency channel number, one or more synchronization reference signals associated with the second type of synchronization reference signal wherein at least one synchronization reference signal associated with the second type of synchronization reference signal fully overlaps in time and frequency with at least one synchronization reference signal associated with the first type of synchronization reference signal; and
perform a procedure, with the secondary serving cell, using the at least one synchronization reference signal associated with the first type of synchronization reference signal, or using the at least one synchronization reference signal associated with the second type of synchronization reference signal.

18. The non-transitory computer-readable medium of claim 14, wherein the second type of synchronization reference signal is deactivated after a threshold duration of time.

19. The non-transitory computer-readable medium of claim 14, wherein the second type of synchronization reference signal is deactivated in association with a deactivation of the secondary serving cell.

20. The non-transitory computer-readable medium of claim 14, wherein the one or more instructions further cause the UE to:
receive a quantity of synchronization reference signal bursts, wherein the second type of synchronization reference signal is deactivated in accordance with the quantity of synchronization reference signal bursts satisfying a threshold.
